(19) United States
(12) Patent Application Publication
(10) Pub. No.: US 2021/0166121 A1
(43) Pub. Date: Jun. 3, 2021

(54) PREDICTING DEVICE AND PREDICTING METHOD

(71) Applicant: Tokyo Electron Limited, Tokyo (JP)

(72) Inventor: Takuro TSUTSUI, Tokyo (JP)

(73) Assignee: Tokyo Electron Limited, Tokyo (JP)

(21) Appl. No.: 17/105,765

(22) Filed: Nov. 27, 2020

(30) Foreign Application Priority Data
Nov. 29, 2019 (JP) 2019-217440

(51) Int. Cl. G06N 3/08; G06N 3/04

(52) U.S. Cl. CPC G06N 3/08; G06N 3/04

(57) ABSTRACT

A predicting device trains a trained model using multiple network sections configured to process the acquired time series data sets and the device state information, and a concatenation section configured to output, as a combined result, a result of combining output data output from each of the multiple network sections. The trained model is then applied to adapt a unit of process performed during manufacture of a processed object.

### CROSS-REFERENCE TO RELATED APPLICATIONS

This patent application is based on and claims priority to Japanese Patent Application No. 2019-217440 filed on Nov. 29, 2019, the entire contents of which are incorporated herein by reference.

### TECHNICAL FIELD

The present disclosure relates to a predicting device, a predicting method, and a predicting computer program product.

### BACKGROUND

Conventionally, in the field of various manufacturing processes, by managing the number of objects processed or a cumulative amount of treatment time, estimation is performed with respect to various items, such as a state in a manufacturing apparatus. Based on a result of the estimation, prediction of replacement time of each part, prediction of timing of maintenance of the manufacturing apparatus, and the like are performed.

Meanwhile, during the manufacturing process, various data are measured along with processing of the objects, and a set of the measured data (a set of multiple types of time series data; hereinafter referred to as a “time series data set”) includes data necessary for the estimation regarding the items to be estimated.

### RELATED ART DOCUMENT

### Patent Document

[Patent Document 1] Japanese Laid-open Patent Application Publication No. 2011-100211

### SUMMARY

The present disclosure provides a predicting device, a predicting method, and a predicting program utilizing time series data sets measured during processing of an object in a manufacturing process.

A predicting device according to one aspect of the present disclosure includes a processor, and a non-transitory computer readable medium that has stored therein a computer program that, when executed by the processor, configures the processor to acquire one or more time series data sets measured along with processing of an object at a predetermined unit of process in a manufacturing process performed by a manufacturing device, and to acquire device state information acquired when the object is processed; and apply the one or more time series data sets in a neural network to develop a trained model. The neural network includes a plurality of network sections each configured to process the acquired time series data sets and the device state information, and a concatenation section configured to combine output data output from each of the plurality of network sections as a result of processing the acquired time series data sets, and to output, as a combined result, a result of combining the output data output from each of the plurality of network sections. The computer program further configures the processor to compare the combined result with a quality indicator to train the trained model such that the combined result output from the concatenation section progressively approaches the quality indicator.

### BRIEF DESCRIPTION OF THE DRAWINGS

FIG. 1 is a first diagram illustrating an example of an overall configuration of a system including a device for performing a semiconductor manufacturing process and a predicting device;

FIGS. 2A and 2B are diagrams each illustrating an example of a predetermined unit of process in the semiconductor manufacturing process;

FIG. 3 is another diagram illustrating examples of the predetermined unit of process in the semiconductor manufacturing process;

FIG. 4 is a diagram illustrating an example of the hardware configuration of the predicting device;

FIG. 5 is a first diagram illustrating an example of training data;

FIGS. 6A and 6B are diagrams illustrating examples of time series data sets;

FIG. 7 is a first diagram illustrating an example of the functional configuration of a training unit;

FIG. 8 is a first diagram illustrating a specific example of processing performed in a branch section;

FIG. 9 is a second diagram illustrating a specific example of the processing performed in the branch section;

FIG. 10 is a third diagram illustrating a specific example of the processing performed in the branch section;

FIG. 11 is a diagram illustrating a specific example of processing performed by a normalizing unit included in each network section;

FIG. 12 is a fourth diagram illustrating a specific example of the processing performed in the branch section;

FIG. 13 is a first diagram illustrating an example of the functional configuration of an inference unit;

FIG. 14 is a first flowchart illustrating a flow of a predicting process;

FIG. 15 is a second diagram illustrating an example of the overall configuration of the system including the device performing a semiconductor manufacturing process and the predicting device;

FIG. 16 is a second diagram illustrating an example of the training data;

FIG. 17 is a diagram illustrating an example of optical emission spectrometer (OES) data;

FIG. 18 is a diagram illustrating a specific example of processing performed by normalizing units included in the respective network sections into which OES data is input;

FIGS. 19A and 19B are diagrams illustrating specific examples of processing of each of the normalizing units;

FIG. 20 is a diagram illustrating a specific example of processing performed by pooling units;

FIG. 21 is a second diagram illustrating an example of the functional configuration of the inference unit; and

FIG. 22 is a second flowchart illustrating the flow of the predicting process.

### DETAILED DESCRIPTION OF EMBODIMENTS

Hereinafter, embodiments will be described with reference to the drawings. For substantially the same components in the present specification and drawings, overlapping descriptions are omitted by giving the same reference numerals.

### First Embodiment

### <Overall Configuration of a System Including a Semiconductor Manufacturing Device and a Predicting Device>

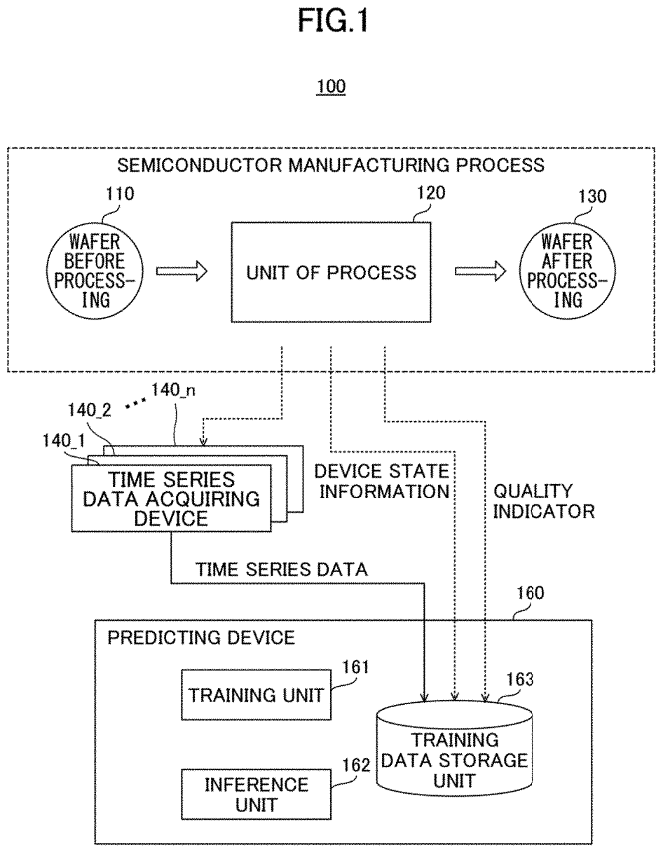

First, the overall configuration of a manufacturing process (a semiconductor manufacturing process in the present embodiment) and a system including a predicting device will be described. FIG. 1 is a first diagram illustrating an example of the overall configuration of the system including a device for performing a semiconductor manufacturing process and the predicting device. As illustrated in FIG. 1, the system 100 includes a device for performing a semiconductor manufacturing process, time series data acquiring devices 140_1 to 140_n, and the predicting device 160.

In the semiconductor manufacturing process, an object (e.g., wafer before processing 110) is processed at a predetermined unit of process 120 to produce a result (e.g., wafer after processing 130). The unit of process 120 described herein is a specialized term related to a particular semiconductor manufacturing process performing in a processing chamber, and details will be described below. Also, a wafer before processing 110 refers to a wafer (substrate) before being processed at the chamber(s) that perform unit of process 120, and wafer after processing 130 refers to a wafer (substrate) after being processed in the chamber (s) that that perform the unit of process 120.

The time series data acquiring devices 140_1 to 140_n each acquire time series data measured along with processing of the wafer before processing 110 at the unit of process 120. The time series data acquiring devices 140_1 to 140_n each measure different properties. It should be noted that the number of measurement items that each of the time series data acquiring devices 140_1 to 140_n measures may be one, or more than one. The time series data measured in accordance with the processing of the wafer before processing 110 includes not only time series data measured during the processing of the wafer before processing 110 but also time series data measured during preprocessing or post-processing of the wafer before processing 110. These processes may include preprocessing and post-processing performed without a wafer (substrate).

The time series data sets acquired by the time series data acquiring devices 140_1 to 140_n are stored in a training data storage unit 163 (a non-transitory memory device) in the predicting device 160, as training data (input data in the training data).

When a wafer before processing 110 is processed at the unit of process 120, device state information is acquired, and the device state information is stored, as training data (input data), in the training data storage unit 163 of the predicting device 160, in association with the time series data sets. Examples of the device state information include:

accumulated data, such as
cumulative value of the number of processes in a semiconductor manufacturing device,
cumulative value of processing time in the semiconductor manufacturing device (e.g., total usage time of parts in the semiconductor manufacturing device, such as a focus ring (F/R), a cover ring (C/R), a cell, or an electrode),
cumulative value of thickness of films deposited in the semiconductor manufacturing device, and
cumulative value used for maintenance management;

information indicating deterioration of various parts (e.g., F/R, C/R, cell, electrode, and the like) of the semiconductor manufacturing device;

information indicating deterioration of members (e.g. inner walls) in a processing space (e.g., chamber) of the semiconductor manufacturing device; and

information such as thickness of deposits that have formed on the parts in the semiconductor manufacturing device.

The device state information is managed for each item individually, and the device state information is reset when parts are replaced or when cleaning is performed.

When a wafer before processing 110 is processed at the unit of process 120, a quality indicator is acquired and stored in the training data storage unit 163 of the predicting device 160 as the training data (correct answer data, or ground truth data) in association with the time series data set. The quality indicator is information representing a result (quality) of the semiconductor manufacturing process, and may be any value that reflects a result or a state of the processed object (wafer) or a result or a state of the processing space, such as an etch rate, CD, film thickness, film quality, or number of particles. The quality indicator may be a value measured directly, or may be a value obtained indirectly (i.e., estimated value).

A predicting program (code that is executed on a processor to implement the algorithms discussed herein) is installed in the predicting device 160. By executing the predicting program, the predicting device 160 functions as a training unit 161 and an inference unit 162.

The training unit 161 performs machine learning using the training data (time series data sets acquired by the time series data acquiring devices 140_1 to 140_n, and the device state information and the quality indicator associated with the time series data sets) to develop a trained model.

Specifically, the training unit 161 processes the time series data sets and the device state information (input data) using multiple network sections, and performs machine learning with respect to the multiple network sections such that a result of combining output data output from the multiple network sections approaches the quality indicator (correct answer data).

The inference unit 162 inputs device state information and time series data sets acquired by the time series data acquiring devices 140_1 to 140_n along with processing of a new object (wafer before processing) at the unit of process 120, to the multiple network sections to which machine learning has been applied. Accordingly, the inference unit 162 infers the quality indicator based on the device state information and the time series data sets acquired along with the processing of the new wafer before processing.

In the inference unit 162, the time series data sets are input repeatedly while changing a value of the device state information, to infer the quality indicator for each of the values of the device state information. The inference unit 162 specifies a value of the device state information when the quality indicator reaches a predetermined threshold. Thus, according to the inference unit 162, it is possible to accurately predict replacement time of parts in the semiconductor manufacturing device, maintenance timing of the semiconductor manufacturing device, and the like. Once trained by the training unit 161, the interference unit embodies a learned model that is able to accurately replacement time for parts, maintenance timing, and/or process adjustments based on age and/or use of equipment. Thus, the trained model can be used to control/adjust semiconductor manufacturing equipment to and the process steps used to make the produced object. While the term “unit” is used herein for devices such as the training unit and the inference unit, it should be understood that the term “circuitry” may be used as well (e.g., “training circuitry” or “inference circuitry”). This is because the circuit device(s) that execute the operations implemented as software code and/or logic operations are configured by the software code and/or logic operations to execute the algorithms described herein.

As described above, the predicting device 160 according to the present embodiment estimates the quality indicator based on the time series data sets acquired along with processing of an object, and predicts replacement time of each part or maintenance timing of the semiconductor manufacturing device based on the estimated quality indicator. This improves the accuracy of the prediction as compared to a case in which replacement time of each part or maintenance timing of the semiconductor manufacturing device is predicted based on only the number of objects processed or cumulative values of processing time and the like.

In addition, the predicting device 160 according to the present embodiment processes time series data sets acquired along with processing of an object, by using multiple network sections. Accordingly, it is possible to analyze time series data sets at a predetermined unit of process in a multifaceted manner, and it is possible to realize a higher inference accuracy as compared to a case, for example, in which time series data sets are processed using a single network section.

### <Predetermined Unit of Process in Semiconductor Manufacturing Process>

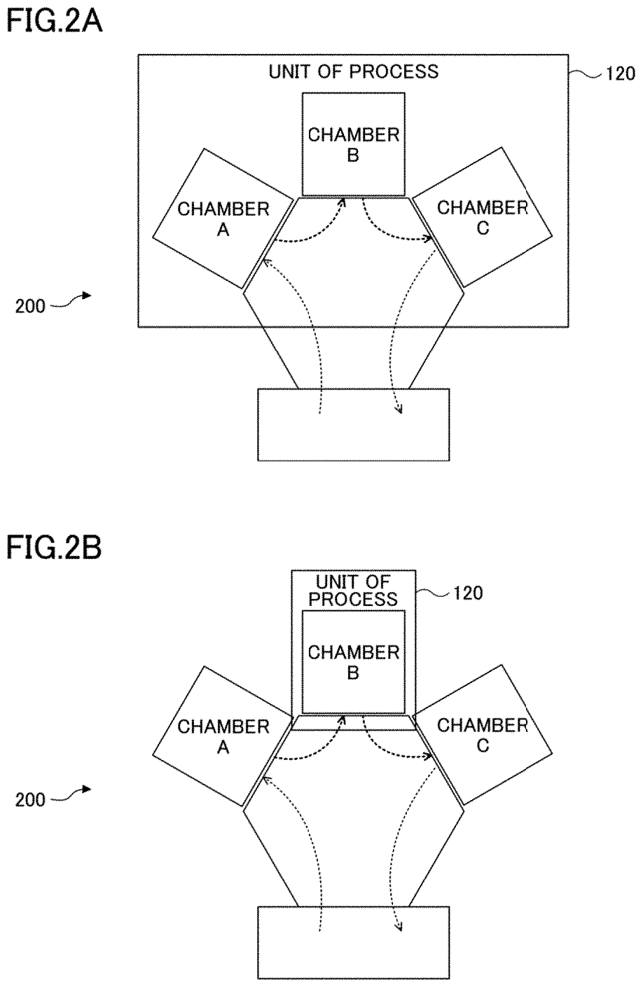

Next, the predetermined unit of process 120 in the semiconductor manufacturing process will be described. FIGS. 2A and 2B are diagrams each illustrating an example of a predetermined unit of process in the semiconductor manufacturing process. As illustrated in FIG. 2A or 2B, a semiconductor manufacturing device 200, which is an example of a substrate processing apparatus, includes multiple chambers. Each of the chambers is an example of a processing space. In the example of FIG. 2, the semiconductor manufacturing device 200 includes chambers A to C, and wafers are processed in each of the chambers A to C.

FIG. 2A illustrates a case in which processes performed in the multiple chambers are respectively defined as a unit of process 120. Wafers are processed in the chamber A, the chamber B, and the chamber C in sequence. In this case, a wafer before processing 110 (FIG. 1) refers to a wafer before being processed in the chamber A, and a wafer after processing 130 refers to a wafer after being processed in the chamber C.

Time series data sets measured in accordance with processing of the wafer before processing 110 in the unit of process 120 of FIG. 2A include:

a time series data set output in accordance with a wafer process performed in the chamber A (first processing space),

a time series data set output in accordance with a wafer process performed in the chamber B (second processing space), and

a time series data set output in accordance with a wafer process performed in the chamber C 10. (third processing space).

Meanwhile, FIG. 2B illustrates a case in which a process performed in a single chamber (in the example of FIG. 2B, the “chamber B”) is defined as a unit of process 120. In this case, a wafer before processing 110 refers to a wafer that has been processed in the chamber A and that is to be processed in the chamber B, and a wafer after processing 130 refers to a wafer that has been processed in the chamber B and is to be processed in the chamber C.

Further, in reference to FIG. 2B, time series data sets measured in accordance with processing of the wafer before processing 110 (FIG. 1) include time series data set measured in accordance with processing of the wafer before processing 110 (FIG. 1) performed in the chamber B.

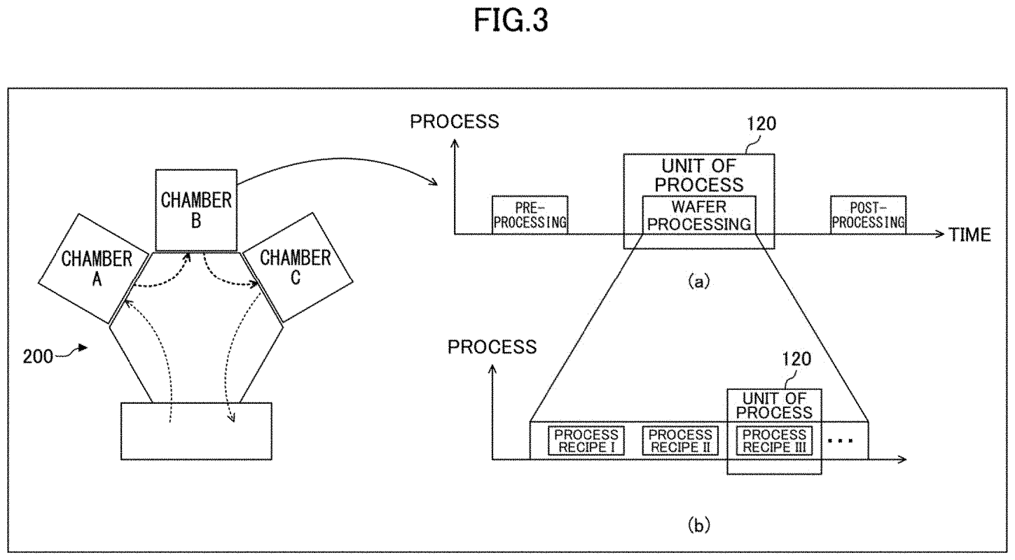

FIG. 3 is another diagram illustrating examples of the predetermined unit of process in the semiconductor manufacturing process. Similar to FIG. 2A or 2B, the semiconductor manufacturing device 200 includes multiple chambers, in each of which a different type of treatment is applied to wafers. However, in another embodiment, the same type of treatment may be applied to wafers in at least two chambers in the multiple chambers.

A diagram (a) of FIG. 3 illustrates a case in which a process (called “wafer processing”) excluding preprocessing and post-processing among processes performed in the chamber B is defined as a unit of process 120. In this case, a wafer before processing 110 (FIG. 1) refers to a wafer before the wafer processing is performed (after the preprocessing is performed), and a wafer after processing 130 (FIG. 1) refers to a wafer after the wafer processing is performed (before the post-processing is performed).

In the unit of process 120 of the time-diagram (a) in FIG. 3, time series data sets measured along with processing of the wafer before processing 110 include time series data sets measured along with the wafer processing of the wafer before processing 110 performed in the chamber B. Thus, it should be understood that a unit of process may be a process performed solely in one chamber, or a process performed sequentially in more than one chambers.

The time-diagram (a) in FIG. 3 illustrates a case in which preprocessing, wafer processing (this process), and post-processing are performed in the same chamber (chamber B) and in which the wafer processing is defined as the unit of process 120. However, in a case in which each of the processing is performed in a different chamber, (e.g., a case in which the preprocessing, the wafer processing, and the post-processing are performed in the chambers A, B, and C, respectively) processing performed in the chamber B may be defined as a unit of process 120. Alternatively, in another embodiment, processing performed in the chamber A or C may be defined as a unit of process 120.

In contrast, a diagram (b) of FIG. 3 illustrates a case in which processing according to one process recipe (“process recipe III” in the example of the time-diagram (b)) included in wafer processing, among processes performed in the chamber B, is defined as a unit of process 120. In this case, a wafer before processing 110 refers to a wafer before a process according to the process recipe III is applied (and after a process according to the process recipe II has been applied). A wafer after processing 130 refers to a wafer after a process according to the process recipe III has been applied (and before a process according to the process recipe IV (not illustrated) is applied).

Further, in the unit of process 120 of the time-diagram (b) in FIG. 3, time series data sets measured along with processing of the wafer before processing 110 include time series data sets measured during the processing according to the process recipe III performed in the chamber B.

### <Hardware Configuration of Predicting Device>

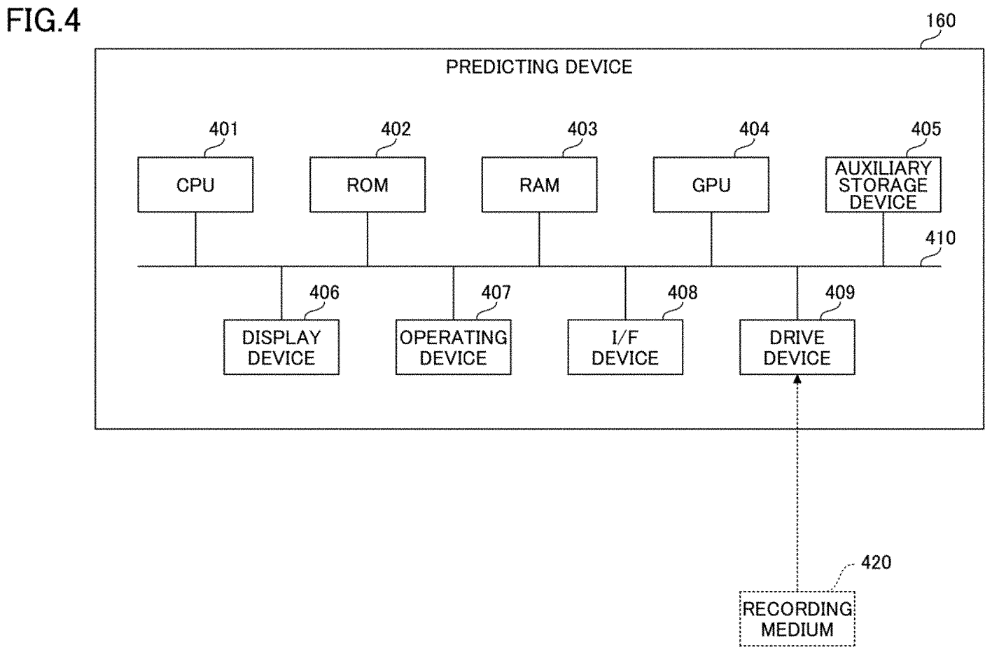

Next, the hardware configuration of the predicting device 160 will be described. FIG. 4 is a diagram illustrating an example of the hardware configuration of the predicting device 160. As illustrated in FIG. 4, the predicting device 160 includes a CPU (Central Processing Unit) 401, a ROM (Read Only Memory) 402, and a RAM (Random Access Memory) 403. The predicting device 160 also includes a GPU (Graphics Processing Unit) 404. Processors (processing circuitry) such as the CPU 401 and the GPU 404, and memories such as the ROM 402 and the RAM 403 constitute a so-called computer, wherein the processors (circuitry) may be configured by software to execute the algorithms described herein.

The predicting device 160 further includes an auxiliary storage device 405, a display device 406, an operating device 407, an interface (I/F) device 408, and a drive device 409. Each hardware element in the predicting device 160 is connected to each other via a bus 410.

The CPU 401 is an arithmetic operation processing device that executes various programs (e.g., predicting program) installed in the auxiliary storage device 405.

The ROM 402 is a non-volatile memory that functions as a main memory unit. The ROM 402 stores programs and data required for the CPU 401 executing the various programs installed in the auxiliary storage device 405. Specifically, the ROM 402 stores a boot program such as BIOS (Basic Input/Output System) or EFI (Extensible Firmware Interface).

The RAM 403 is a volatile memory, such as a DRAM (Dynamic Random Access Memory) or an SRAM (Static Random Access Memory), and functions as a main memory unit. The RAM 403 provides a work area on which the various programs installed in the auxiliary storage device 405 are loaded when the various programs are executed by the CPU 401.

The GPU 404 is an arithmetic operation processing device for image processing. When the CPU 401 executes the predicting program, the GPU 404 performs high-speed calculation of various image data (i.e., the time series data sets in the present embodiment) by using parallel processing. The GPU 404 includes an internal memory (GPU memory) to temporarily retain information needed to perform parallel processing of the various image data.

The auxiliary storage device 405 stores the various programs (computer executable code) and various data used when the various programs are executed by the CPU 401. For example, the training data storage unit 163 is implemented by the auxiliary storage device 405.

The display device 406 displays an internal state of the predicting device 160. The operating device 407 is an input device used by an administrator of the predicting device 160 when the administrator inputs various instructions to the predicting device 160. The I/F device 408 is a connecting device for connecting and communicating with a network (not illustrated).

The drive device 409 is a device into which a recording medium 420 is loaded. Examples of the recording medium 420 include a medium for optically, electrically, or magnetically recording information, such as a CD-ROM, a flexible disk, and a magneto-optical disk. In addition, examples of the recording medium 420 may include a semiconductor memory or the like that electrically records information, such as a ROM, and a flash memory.

The various programs installed in the auxiliary storage device 405 are installed when, for example, a recording medium 420 distributed is loaded into the drive device 409 and the various programs recorded in the recording medium 420 are read out by the drive device 409. Alternatively, the various programs installed in the auxiliary storage device 405 may be installed by being downloaded via a network (not illustrated).

### <Example of Training Data>

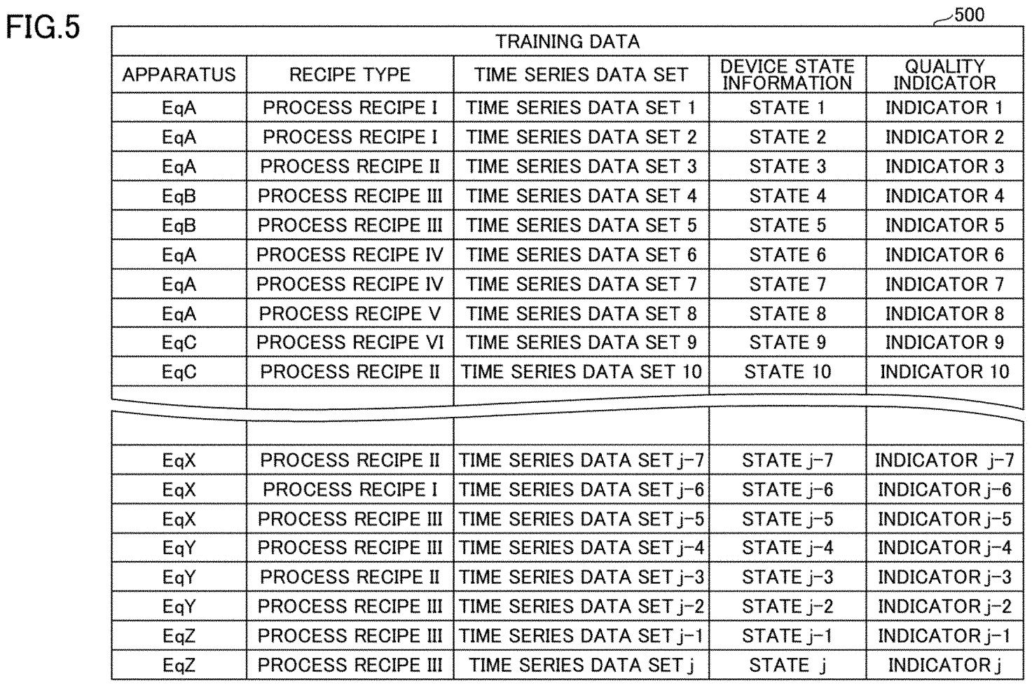

Next, training data that is read out from the training data storage unit 163 when the training unit 161 performs machine learning will be described. FIG. 5 is a first diagram illustrating an example of the training data. As illustrated in FIG. 5, the training data 500 includes “APPARATUS”, “RECIPE TYPE”, “TIME SERIES DATA SET”, “DEVICE STATE INFORMATION”, and “QUALITY INDICATOR” as items of information. Here, a case in which the predetermined unit of process 120 is a process according to one process recipe will be described.

The “APPARATUS” field stores an identifier indicating a semiconductor manufacturing device (e.g., semiconductor manufacturing device 200) whose quality index is monitored. The “RECIPE TYPE” field stores an identifier (e.g., process recipe I) indicating a process recipe, which is performed when a corresponding time series data set is measured, among process recipes performed in the corresponding semiconductor manufacturing device (e.g., EqA).

The “TIME SERIES DATA SET” field stores time series data sets measured by the time series data acquiring devices 140_1 to 140_n when processing according to the process recipe indicated by the “RECIPE TYPE” is performed in the semiconductor manufacturing device indicated by the “APPARATUS”.

The “DEVICE STATE INFORMATION” field stores device state information that is acquired just after the corresponding time series data sets (for example, time series data set 1) are measured by the time series data acquiring devices 140_1 to 140_n.

The “QUALITY INDICATOR” field stores a quality indicator acquired just after the corresponding time series data sets (for example, time series data set 1) are measured by the time series data acquiring device 140_1 to 140_n.

### <Example of Time Series Data Set>

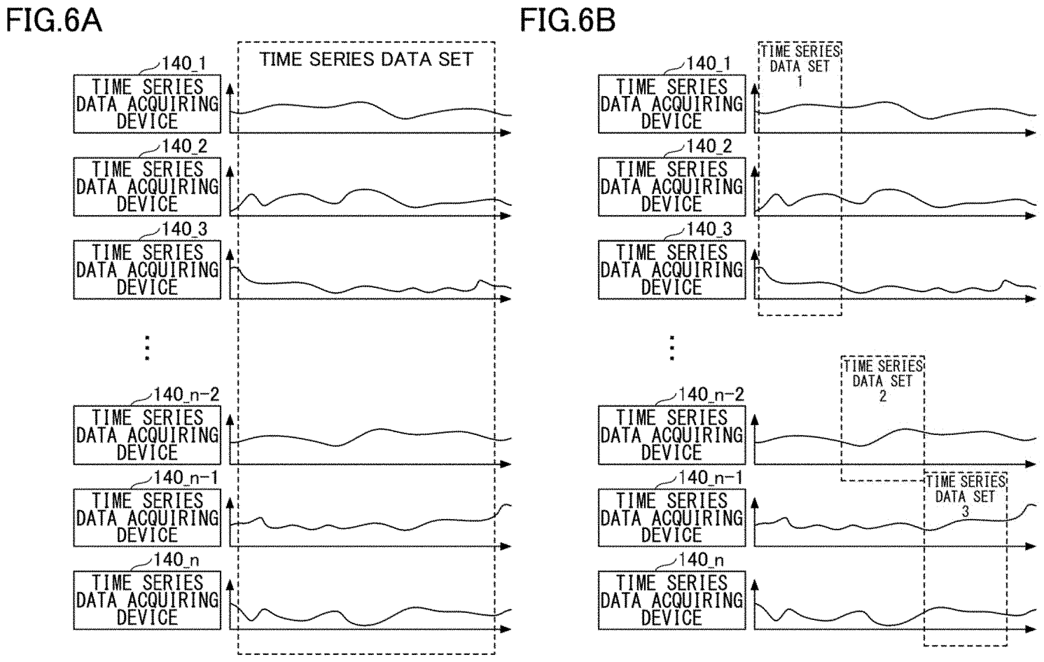

Next, specific examples of the time series data sets measured by the time series data acquiring devices 140_1 to 140_n will be described. FIGS. 6A and 6B are diagrams illustrating examples of the time series data sets. In the example of FIGS. 6A and 6B, to simplify the explanation, each of the time series data acquiring devices 140_1 to 140_n measures one-dimensional data. However, at least one of the time series data acquiring devices 140_1 to 140_n may measure two-dimensional data (set of multiple types of one-dimensional data).

FIG. 6A represents time series data sets in which the unit of process 120 is as illustrated in any of FIG. 2B, the diagram (a) of FIG. 3, and the diagram (b) of FIG. 3. In this case, each of the time series data acquiring devices 140_1 to 140_n acquires time series data measured during processing of a wafer before processing 110 in the chamber B. Each of the time series data acquiring devices 140_1 to 140_n acquires time series data measured within the same time frame as the time series data set.

In contrast, FIG. 6B represents time series data sets when the unit of process 120 is as illustrated in FIG. 2A. In this case, the time series data acquiring devices 140_1 to 140_3 acquire, for example, the time series data set 1 measured along with processing of a wafer before processing in the chamber A. The time series data acquiring device 140_n-2 acquires, for example, the time series data set 2 measured along with processing of the wafer in the chamber B. The time series data acquiring devices 140_n-1 and 140_n acquire the time series data set 3, which is measured along with processing of the wafer in the chamber C, for example.

FIG. 6A illustrates the case in which each of the time series data acquiring devices 140_1 to 140_n acquires, as the time series data set, time series data measured along with the processing of the wafer before processing in the chamber B during the same time frame. However, each of the time series data acquiring devices 140_1 to 140_n may acquire, as the time series data sets, multiple sets of time series data each measured during a different range of time along with processes of a wafer before processing performed in the chamber B.

Specifically, the time series data acquiring devices 140_1 to 140_n may acquire time series data measured during preprocessing, as the time series data set 1. The time series data acquiring devices 140_1 to 140_n may acquire time series data measured during wafer processing, as the time series data set 2. Further, the time series data acquiring devices 140_1 to 140_n may acquire time series data measured during post-processing, as the time series data set 3.

Alternatively, the time series data acquiring devices 140_1 to 140_n may acquire time series data measured during processing in accordance with the process recipe I, as the time series data set 1. The time series data acquiring devices 140_1 to 140_n may acquire time series data measured during processing in accordance with the process recipe II, as the time series data set 2. Further, the time series data acquiring devices 140_1 to 140_n may acquire time series data measured during processing in accordance with the process recipe III, as the time series data set 3.

### <Functional Configuration of Training Unit>

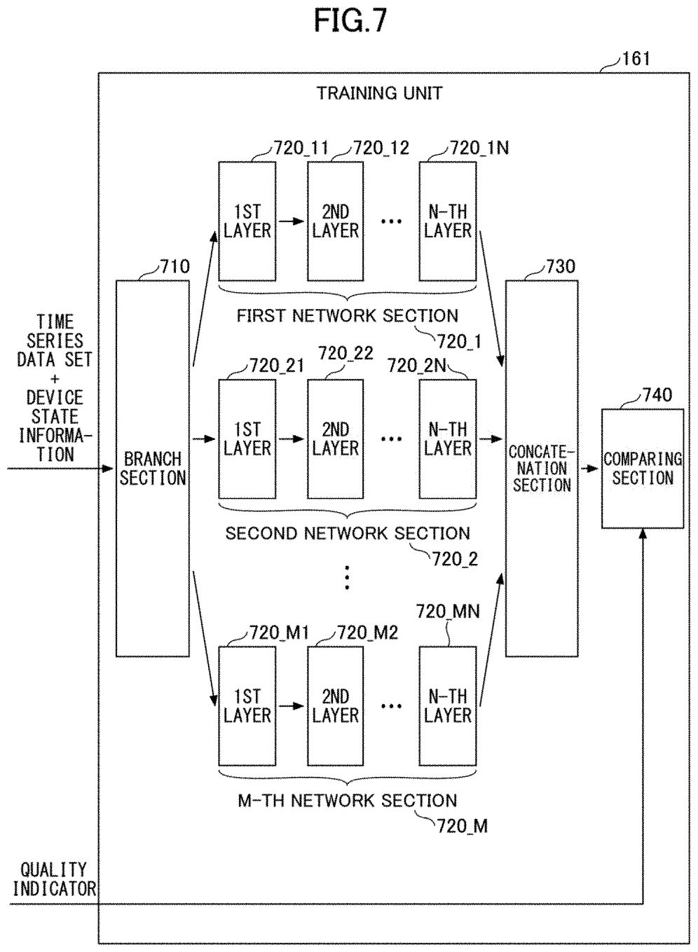

Next, the functional configuration of the training unit 161 will be described. FIG. 7 is a first diagram illustrating an example of the functional configuration of the training unit 161. The training unit 161 includes a branch section 710, multiple network sections including a first network section 720_1, a second network section 720_2, . . . , and an M-th network section 720_M, a concatenation section 730, and a comparing section 740.

The branch section 710 is an example of an acquisition unit, and reads out time series data sets and device state information associated with the time series data sets from the training data storage unit 163.

The branch section 710 controls input to the network sections of the first network section 720_1 to the M-th network section 720_M, so that the time series data sets and the device state information are processed by the network sections of the first network section 720_1 to the M-th network section 720_M.

The first to M-th network sections (720_1 to 720_M) are configured based on a convolutional neural network (CNN), which include multiple layers.

Specifically, the first network section 720_1 has a first layer 720_11, a second layer 720_12, . . . , and an N-th layer 720_1N. Similarly, the second network section 720_2 has a first layer 720_21, a second layer 720_22, . . . , and an N-th layer 720_2N. Other network sections are also configured similarly. For example, the M-th network section 720_M has a first layer 720_M1, a second layer 720_M2, . . . , and an N-th layer 720_MN.

Each of the first to N-th layers (720_11 to 720_1N) in the first network section 720_1 performs various types of processing such as normalization processing, convolution processing, activation processing, and pooling processing. Similar types of processing are performed at each of the layers in the second to M-th network sections (720_2 to 720_M).

The concatenation section 730 combines each output data output from the N-th layers (720_1N to 720_MN) of the first to M-th network sections (720_1 to 720_M), and outputs a combined result to the comparing section 740. Similar to the network sections (720_1 to 720_M), the concatenation section 730 may be configured to be trained by machine learning. The concatenation section 730 may be implemented as a convolutional neural network or other type of neural network.

The comparing section 740 compares the combined result output from the concatenation section 730, with the quality indicator (correct answer data) read out from the training data storage unit 163, to calculate error. The training unit 161 performs machine learning with respect to the first to M-th network sections (720_1 to 720_M) and the concatenation section 730 by error backpropagation, such that error calculated by the comparing section 740 satisfies the predetermined condition.

By performing the machine learning, model parameters of each of the first to M-th network sections 720_1 to 720_M and the model parameters of the concatenation section 730 are optimized to predict device state information for adjustment of processes used in the manufacture of a processed substrate.

### <Details of Processing in Each Part of the Training Unit>

Next, details of the processing performed in each part (in particular, the branch section) of the training unit 161 will be described with reference to specific examples.

(1) Details of Processing (1) Performed in the Branch Section

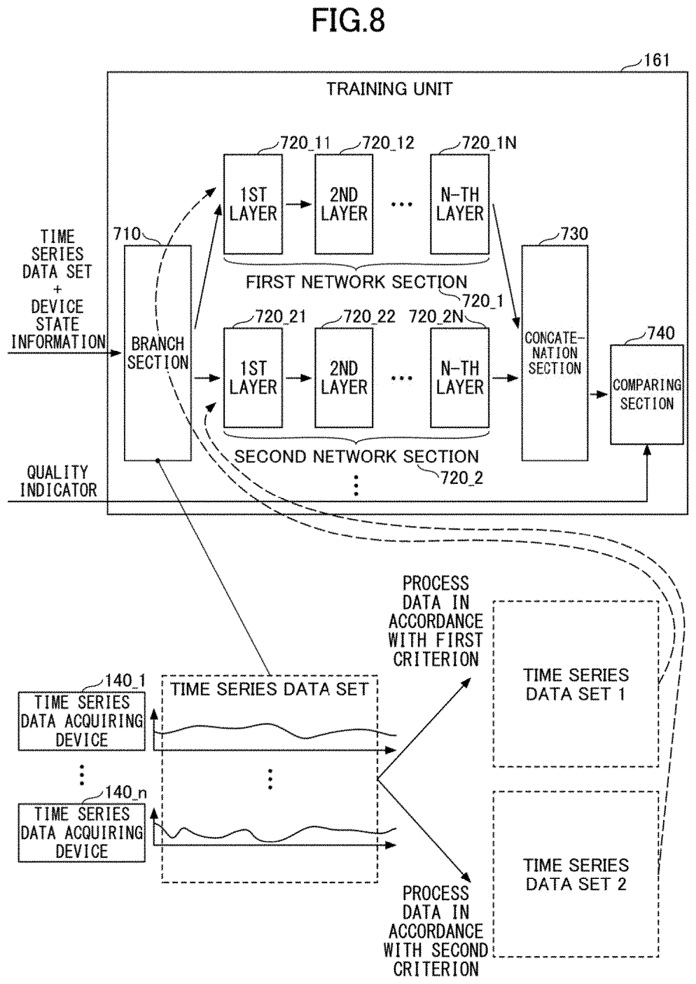

First, the processing of the branch section 710 will be described in detail. FIG. 8 is a first diagram illustrating a specific example of the processing performed in the branch section 710. In the case illustrated in FIG. 8, the branch section 710 generates time series data set 1 (first time series data set) by processing the time series data sets measured by the time series data acquiring devices 140_1 to 140_n in accordance with a first criterion, and inputs the time series data set 1 into the first network section 720_1.

The branch section 710 also generates time series data set 2 (second time series data set) by processing the time series data sets measured by the time series data acquiring devices 140_1 to 140_n in accordance with a second criterion, and inputs the time series data set 2 into the second network section 720_2.

The branch section 710 inputs the device state information to one of the first layer 720_11 to the N-th layer 720_1N in the first network section 720_1. Within the layer to which the device state information is entered by the branch section 710, the device state information is combined with a signal to which the convolution processing is applied. It is more preferable that the device state information is input to a layer that is positioned closer to the branch section 710 among the layers (720_11 to 720_1N) in the first network section 720_1, and that is combined, in the layer, with the signal to which the convolution processing is applied.

The branch section 710 inputs the device state information to one of the first layer 720_21 to the N-th layer 720_2N in the second network section 720_2. Within the layer to which the device state information is entered by the branch section 710, the device state information is combined with a signal to which the convolution processing is applied. It is more preferable that the device state information is input to a layer that is positioned closer to the branch section 710 among the layers (720_21 to 720_2N) in the second network section 720_2, and that is combined, in the layer, with the signal to which the convolution processing is applied.

As described above, because the training unit 161 is configured such that multiple sets of data (e.g., time series data set 1 and time series data set 2 in the above-described example) are generated by processing the time series data sets in accordance with each of the different criteria (e.g., first criterion and second criterion) and that each of the multiple sets of data is processed in a different network section, and because machine learning is performed on the above-described configuration, time series data sets at the unit of process 120 can be analyzed in a multifaceted manner. As a result, a model (inference unit 162) that realizes a high inference accuracy can be generated as compared to a case in which time series data sets are processed using a single network section.

The example of FIG. 8 illustrates a case in which two sets of data are generated by processing the time series data sets in accordance with each of the two types of criteria. However, more than two sets of data may be generated by processing the time series data sets in accordance with each of three or more types of criteria. Further, various types of criteria may be used for processing time series data sets. For example, if the time series data sets includes data obtained by optical emission spectroscopy, an average of intensity of light may be used as a criterion. In addition, a characteristic value of a wafer such as a film thickness of a wafer, or a characteristic value of wafers in a production lot, may be used as a criterion. Further, a value indicating a state of a chamber, such as a usage time of the chamber or the number of times of preventive maintenance, may also be used as a criterion.

(2) Details of Processing (2) Performed in the Branch Section

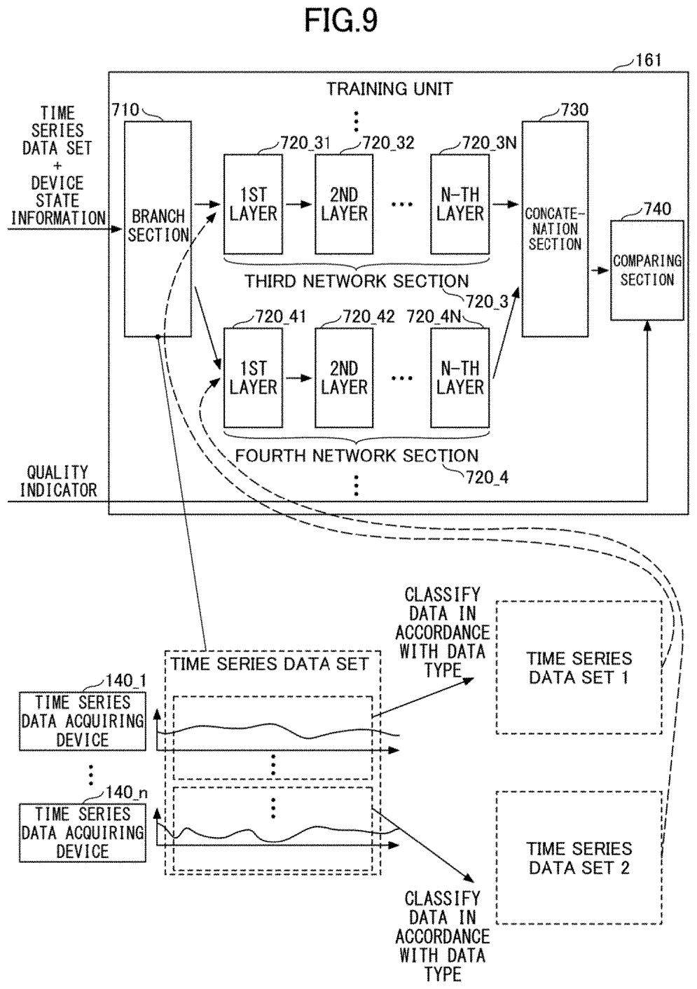

Next, another processing performed in the branch section 710 will be described in detail. FIG. 9 is a second diagram illustrating a specific example of the processing performed in the branch section 710. In the case of FIG. 9, the branch section 710 generates the time series data set 1 (first time series data set) and the time series data set 2 (second time series data set) by classifying the time series data sets measured by the time series data acquiring devices 140_1 to 140_n in accordance with data types. The branch section 710 inputs the generated time series data set 1 into the third network section 720_3 and inputs the generated time series data set 2 into the fourth network section 720_4.

The branch section 710 inputs the device state information to one of the first layer 720_31 to the N-th layer 720_3N of the third network section 720_3. In the layer to which the device state information is entered by the branch section 710, the device state information is combined with a signal to which the convolution processing is applied. It is more preferable that the device state information is input to a layer that is positioned closer to the branch section 710 among the layers (720_31 to 720_3N) in the third network section 720_3, and that is combined, in the layer, with the signal to which the convolution processing is applied.

The branch section 710 inputs the device state information to one of the first layer 720_41 to the N-th layer 720_4N in the fourth network section 720_4. In the layer to which the device state information is entered by the branch section 710, the device state information is combined with a signal to which the convolution processing is applied. It is more preferable that the device state information is input to a layer that is positioned closer to the branch section 710 among the layers (720_41 to 720_4N) in the fourth network section 720_4, and that is combined, in the layer, with the signal to which the convolution processing is applied.

As described above, because the training unit 161 is configured to classify the time series data sets into multiple sets of data (e.g., time series data set 1 and time series data set 2 in the above-described example) in accordance with data type, and to process each of the multiple sets of data in a different network section, and because machine learning is performed on the above-described configuration, the unit of process 120 can be analyzed in a multifaceted manner. As a result, it is possible to generate a model (inference unit 162) that achieves a high inference accuracy, as compared to a case in which machine learning is performed by inputting time series data sets into a single network section.

In the example of FIG. 9, the time series data sets are grouped (classified) in accordance with differences in data type due to differences in the time series data acquiring devices 140_1 to 140_n. For example, the time series data sets may be grouped into a data set acquired by optical emission spectroscopy and a data set acquired by mass spectrometry. However, time series data sets may be grouped in accordance with a time range for which data is acquired. For example, in a case in which the time series data sets consist of time series data measured along with processes according to multiple process recipes (e.g., process recipes I to III), the time series data sets may be grouped into three groups (e.g., time series data sets 1 to 3) according to the time ranges of the respective process recipes. Alternatively, the time series data sets may be grouped in accordance with environmental data (e.g., ambient pressure, air temperature). Further, the time series data sets may be grouped in accordance with data obtained during operations performed before or after a process of acquiring the time series data sets, such as conditioning or cleaning of a chamber.

(3) Details of Processing (3) Performed in the Branch Section

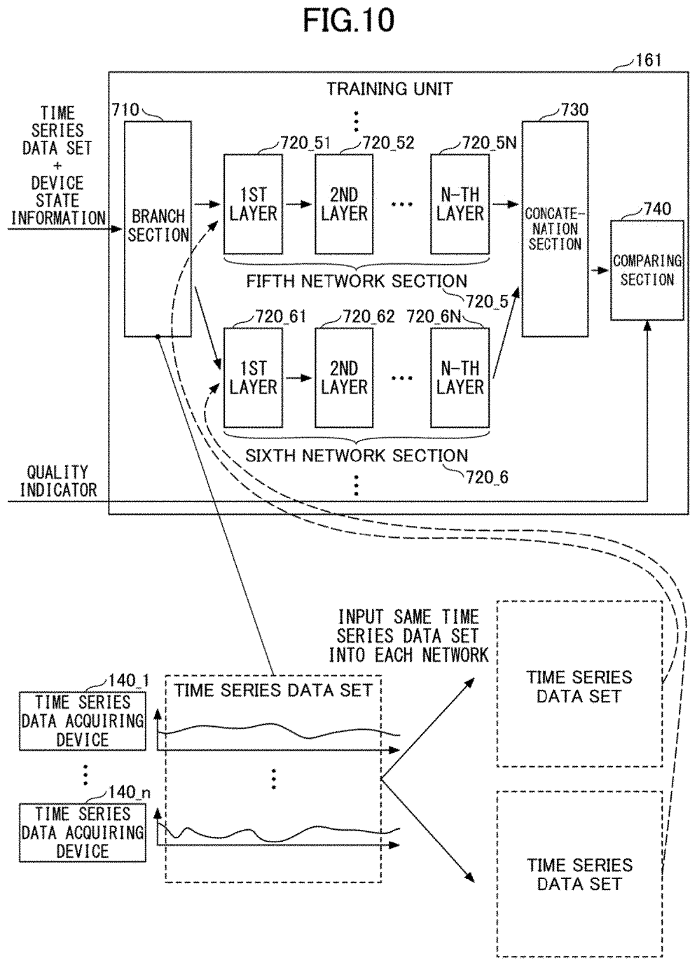

Next, yet another processing performed in the branch section 710 will be described in detail. FIG. is a third diagram illustrating a specific example of the processing performed in the branch section 710. In the case of FIG. 10, the branch section 710 inputs the same time series data sets acquired by the time series data acquiring devices 140_1 to 140_n to each of the fifth network section 720_5 and the sixth network section 720_6. In each of the fifth network section 720_5 and the sixth network section 720_6, a different process (normalization process) is applied to the same time series data sets.

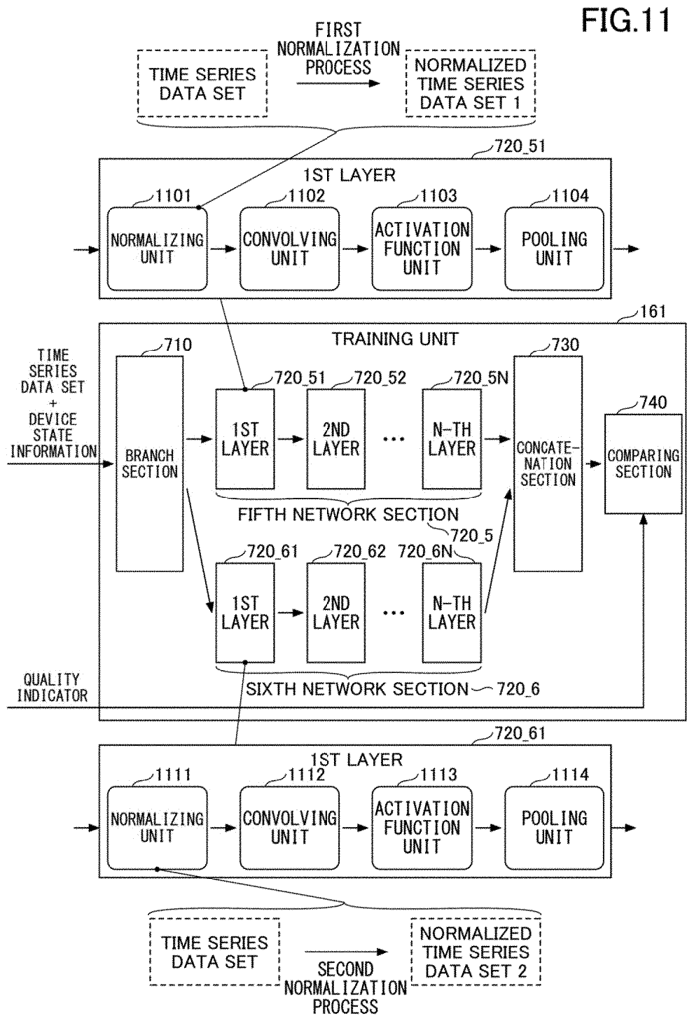

FIG. 11 is a diagram illustrating a specific example of processing performed by a normalizing unit included in each of the network sections. As illustrated in FIG. 11, each of the layers of the fifth network section 720_5 includes a normalizing unit, a convolving unit, an activation function unit, and a pooling unit.

The example of FIG. 11 illustrates a normalizing unit 1101, a convolving unit 1102, an activation function unit 1103, and a pooling unit 1104 included in the first layer 720_51 in the fifth network section 720_5.

Among these, the normalizing unit 1101 applies a first normalization process to the time series data sets that are input from the branch section 710, to generate the normalized time series data set 1 (first time series data set). The normalized time series data set 1 is combined with the device state information input by the branch section 710, and is input to the convolving unit 1102. The first normalization process and a process of combining the normalized time series data set 1 with the device state information, performed by the normalizing unit 1101, may be performed in another layer in the fifth network section 720_5 other than the first layer 720_51, but more preferably, may be performed in a layer that is positioned closer to the branch section 710 among the layers (720_51 to 720_5N) in the fifth network section 720_5.

In addition, the example of FIG. 11 also illustrates a normalizing unit 1111, a convolving unit 1112, an activation function unit 1113, and a pooling unit 1114 included in the first layer 720_61 in the sixth network section 720_6.

Among these, the normalizing unit 1111 applies a second normalization process to the time series data sets that are input from the branch section 710, to generate the normalized time series data set 2 (second time series data set). The normalized time series data set 2 is combined with the device state information input by the branch section 710 and is input to the convolving unit 1112. The second normalization process and a process of combining the normalized time series data set 2 with the device state information, performed by the normalizing unit 1111, may be performed in another layer in the sixth network section 720_6 other than the first layer 720_61, but more preferably, may be performed in a layer that is positioned closer to the branch section 710 among the layers (720_61 to 720_6N) in the sixth network section 720_6.

As described above, because the training unit 161 is configured to process time series data sets using multiple network sections each including a normalizing unit that performs normalization using a different method from other normalizing units, and because machine learning is performed on the above-described configuration, the unit of process 120 can be analyzed in a multifaceted manner. As a result, a model (inference unit 162) that achieves a high inference accuracy can be generated, as compared to a case in which a single type of normalization is applied to the time series data sets using a single network section. Moreover, the model developed in the training unit 161 may be employed in the inference unit 162 to identify processes that will likely result in predicted conditions that may adversely affect a quality of a manufactured semiconductor component. By the predicting the condition with the trained model, the trained model may be used to control of semiconductor manufacturing equipment to trigger supervised or automated maintenance operations on a process chamber; adjustment of at least one of a RF power system (e.g., adjustment of RF power levels and/or RF waveform) for generating plasma or a gas input (or process gas composition) and/or gas exhaust operation, supervised or automated calibration operations (e.g., gas flow and/or RF waveforms for generating plasma, supervised or automated adjustment of gas flow levels, supervised or automated replacement of components such as electrostatic chuck, which may become wasted over time, and the like

(4) Details of Processing (4) Performed in the Branch Section

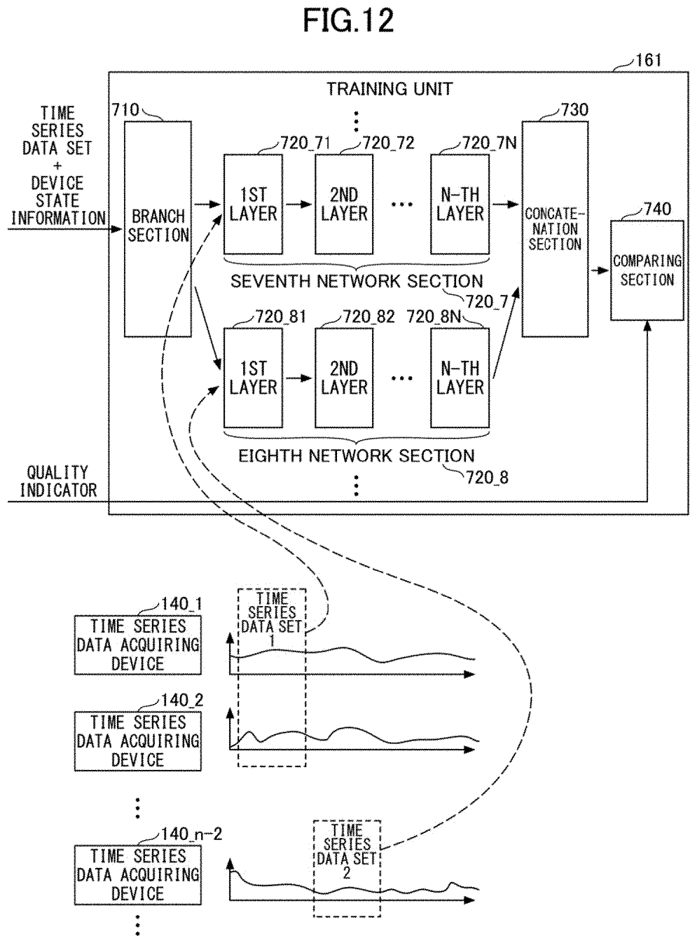

Next, still another processing performed in the branch section 710 will be described in detail. FIG. 12 is a fourth diagram illustrating a specific example of the processing performed in the branch section 710. In the example of FIG. 12, the branch section 710 inputs the time series data set 1 (first time series data set) measured along with processing of a wafer in the chamber A to the seventh network section 720_7, among the time series data sets measured by the time series data acquiring devices 140_1 to 140_n.

The branch section 710 inputs the time series data set 2 (second time series data set) measured along with the processing of the wafer in the chamber B to the eighth network section 720_8, among the time series data sets measured by the time series data acquiring devices 140_1 to 140_n.

The branch section 710 inputs the device state information acquired when the wafer is processed in the chamber A to one of the first layer 720_71 to the N-th layer 720_7N in the seventh network section 720_7. In the layer to which the device state information is entered by the branch section 710, the device state information is combined with a signal to which the convolution processing is applied. It is more preferable that the device state information is input to a layer that is positioned closer to the branch section 710 among the layers (720_71 to 720_7N) in the seventh network section 720_7, and that is combined, in the layer, with the signal to which the convolution processing is applied.

The branch section 710 inputs the device state information acquired when the wafer is processed in the chamber B to one of the first layer 720_81 to the N-th layer 720_8N in the eighth network section 720_8. In the layer to which the device state information is entered by the branch section 710, the device state information is combined with a signal to which the convolution processing is applied. It is more preferable that the device state information is input to a layer that is positioned closer to the branch section 710 among the layers (720_81 to 720_8N) in the eighth network section 720_8, and that is combined, in the layer, with the signal to which the convolution processing is applied.

As described above, because the training unit 161 is configured to process different time series data sets, each being measured along with processing in a different chamber (first processing space and second processing space), by using respective network sections, because machine learning is performed on the above-described configuration, the unit of process 120 can be analyzed in a multifaceted manner. As a result, a model (inference unit 162) that achieves a high inference accuracy can be generated, as compared to a case in which each of the time series data sets is configured to be processed using a single network section.

### <Functional Configuration of Inference Unit>

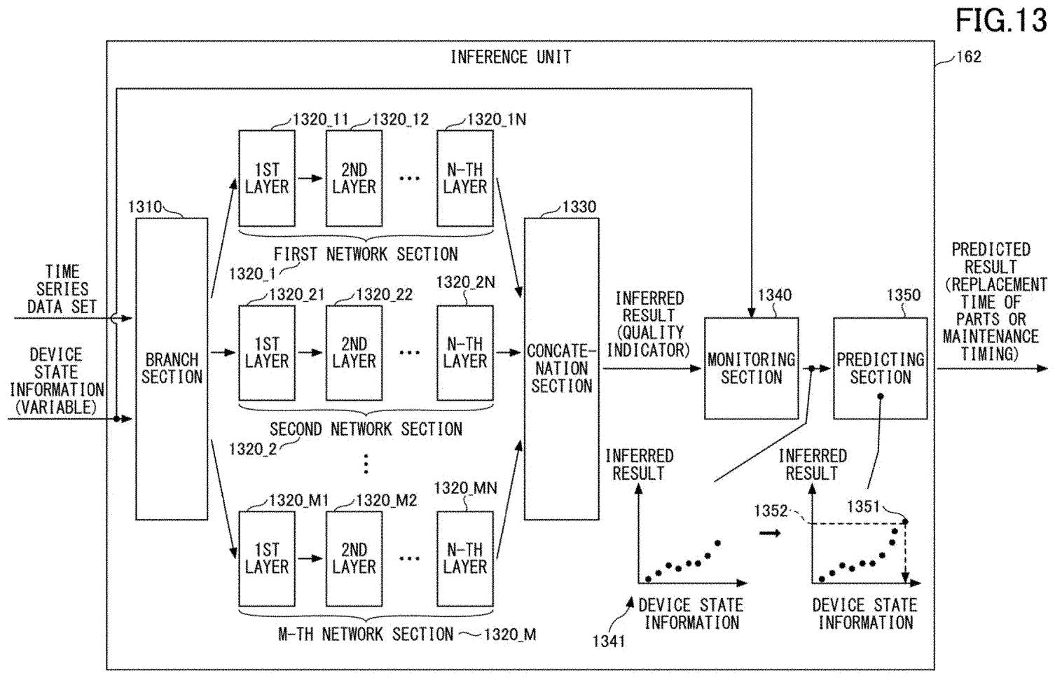

Next, the functional configuration of the inference unit 162 will be described. FIG. 13 is a first diagram illustrating an example of the functional configuration of the inference unit 162. As illustrated in FIG. 13, the inference unit 162 includes a branch section 1310, first to M-th network sections 1320_1 to 1320_M, a concatenation section 1330, a monitoring section 1340, and a predicting section 1350.

The branch section 1310 acquires the time series data sets newly measured by the time series data acquiring devices 140_1 to 140_N after the time series data sets, which were used by the training unit 161 for machine learning, were measured, and acquires the device state information. The branch section 1310 is also configured to cause the first to M-th network sections (1320_1 to 1320_M) to process the time series data sets and the device state information. Note that the device state information can be varied (i.e., the device state information is treated as a configurable parameter in the inference unit 162), and the branch section 1310 repeatedly inputs the same time series data sets to the first to M-th network sections (1320_1 to 1320_M) while changing a value of the device state information.

The first to M-th network sections (1320_1 to 1320_M) are implemented, by performing machine learning in the training unit 161 to optimize model parameters of each of the layers in the first to M-th network sections (720_1 to 720_M).

The concatenation section 1330 is implemented by the concatenation section 730 whose model parameters have been optimized by performing machine learning in the training unit 161. The concatenation section 1330 combines output data output from an N-th layer 1320_1N of the first network section 1320_1 to an N-th layer 1320_1N of the M-th network section 1320_M, to output a result of inference (quality indicator) for each value of the device state information.

The monitoring section 1340 acquires the quality indicators output from the concatenation section 1330 and the corresponding values of the device state information. The monitoring section 1340 generates a graph having the device state information as the horizontal axis and the quality indicator as the vertical axis, by plotting sets of the acquired quality indicators and the corresponding values of the device state information. The graph 1341 illustrated in FIG. 13 is an example of the graph generated by the monitoring section 1340.

The predicting section 1350 specifies the value of the device state information (point 1351 in the example of FIG. 13), in which the quality indicator acquired for each of the values of the device state information first exceeds a predetermined threshold 1352. The predicting section 1350 also predicts replacement time of each part in the semiconductor manufacturing device or timing of maintenance of the semiconductor manufacturing device, based on the specified value of the device state information and a current value of the device state information. For example, when the predicting section 1350 predicts replacement time of each part in the semiconductor manufacturing device, the predicting section 1350 may output the predicted replacement time to the display device 406. Also, if the current time is close to the replacement time predicted by the predicting section 1350, the predicting section 1350 may display a warning message on the display device 406. Further, if the current time reaches the predicted replacement time, the predicting section 1350 may issue an instruction to a controller of the semiconductor manufacturing device, to stop operations of the semiconductor manufacturing device.

It should be noted that the predetermined threshold 1352 may be determined with respect to a quality indicator related to necessity of maintenance of the semiconductor manufacturing device. Alternatively, the predetermined threshold 1352 may be determined with respect to a quality indicator related to necessity of replacement of parts within the semiconductor manufacturing device.

As described above, the inference unit 162 is generated by machine learning being performed in the training unit 161, which analyzes the time series data sets with respect to the predetermined unit of process 120 in a multifaceted manner. Thus, the inference unit 162 can also be applied to different process recipes, different chambers, and different devices. Alternatively, the inference unit 162 can be applied to a chamber before maintenance and to the same chamber after its maintenance. That is, the inference unit 162 according to the present embodiment eliminates the need, for example, to maintain or retrain a model after maintenance of a chamber is performed, which is required in conventional systems.

### <Flow of Predicting Process>

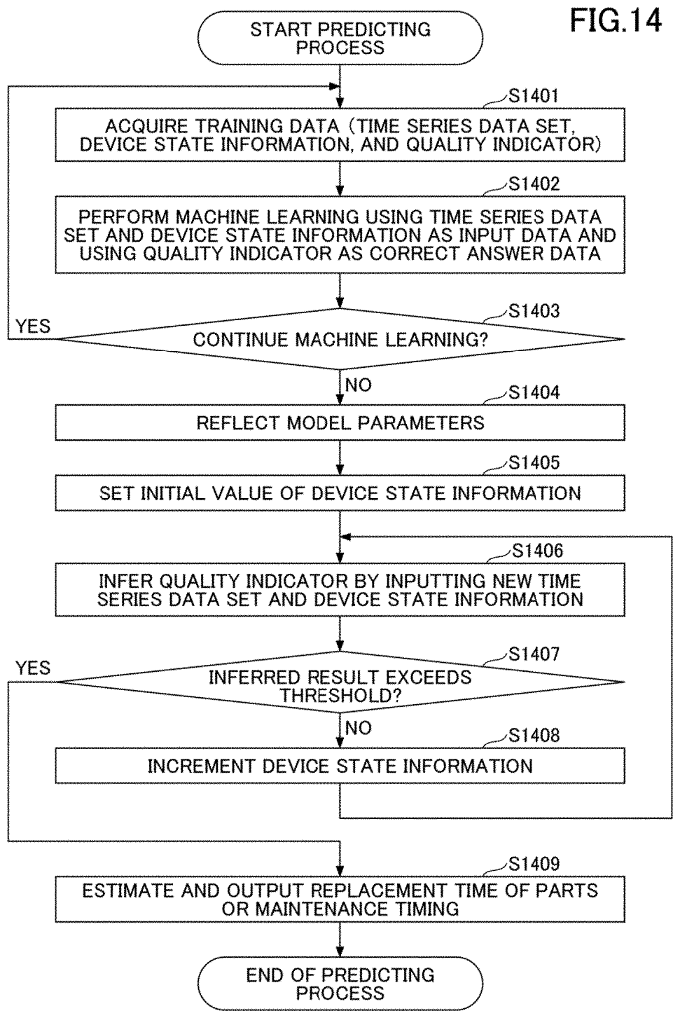

Next, an overall flow of the predicting process performed by the predicting device 160 will be described. FIG. 14 is a first flowchart illustrating the flow of the predicting process.

In step S1401, the training unit 161 acquires time series data sets, device state information, and a quality indicator, as training data.

In step S1402, the training unit 161 performs machine learning by using the acquired training data. Of the acquired training data, the time series data sets and the device state information are used as input data, and the quality indicator is used as correct answer data.

In step S1403, the training unit 161 determines whether to continue the machine learning. If machine learning is continued by acquiring further training data (in a case of YES in step S1403), the process returns to step S1401. Meanwhile, if the machine learning is terminated (in a case of NO in step S1403), the process proceeds to step S1404.

In step S1404, the inference unit 162 generates the first to M-th network sections 1320_1 to 1320_M by reflecting model parameters optimized by the machine learning.

In step S1405, the inference unit 162 initialize the device state information. As the initial value of the device state information, for example, the inference unit 162 may acquire a value of the device state information that has been measured along with processing of a new wafer before processing.

In step S1406, the inference unit 162 infers the quality indicator, by inputting time series data sets measured along with the processing of a new wafer before processing and by inputting the value of the device state information.

In step S1407, the inference unit 162 determines whether or not the inferred quality indicator exceeds a predetermined threshold. If it is determined in step S1407 that the inferred quality indicator does not exceed the predetermined threshold (in the case of NO in step S1407), the process proceeds to step S1408.

In step S1408, the inference unit 162 increments the value of the device state information by a predetermined increment, and the process returns to step S1406. The inference unit 162 continues to increment the value of the device state information until it is determined that the inferred quality indicator exceeds the predetermined threshold.

Meanwhile, if it is determined in step S1407 that the inferred quality indicator exceeds the predetermined threshold (in the case of YES in step S1407), the process proceeds to step S1409.

In step S1409, the inference unit 162 specifies the value of the device state information when the inferred quality indicator exceeds the predetermined threshold. Based on the specified value of the device state information, the inference unit 162 predicts (i.e., estimates) and outputs replacement time of parts of the semiconductor manufacturing device or maintenance timing of the semiconductor manufacturing device.

### SUMMARY

As is apparent from the above description, the predicting device according to the first embodiment performs the following steps:

a) time series data sets and device state information measured along with processing of an object at a predetermined unit of process in the manufacturing process are acquired;

b) with respect to the acquired time series data sets, the following one of b-1), b-2), and b-3) is performed;
b-1) a first time series data set and a second time series data set are generated by processing the acquired time series data sets in accordance with the first and second criteria respectively, the first and second time series data sets are processed with the device state information by using multiple network sections, and output data output from each of the multiple network sections is combined,
b-2) the acquired time series data sets are classified into multiple groups in accordance with data types or time ranges, the groups are processed with the device state information by using multiple network sections, and output data output from each of the multiple network sections is combined, or
b-3) the acquired time series data sets are input to multiple network sections each performing normalization based on a different method, to cause the acquired time series data sets to be processed in each of the multiple network sections with the device state information, and output data output from each of the multiple network sections is combined;

c) machine learning is performed with respect to the multiple network sections, such that a result of the combining of the output data output from each of the multiple network sections approaches the quality indicator obtained when processing the object at the predetermined unit of process in the manufacturing process;

d) while changing a value of the device state information, newly obtained time series data sets, which are measured by time series data acquiring devices along with processing of a new object, are processed by using the multiple network sections to which a result of the machine learning is applied, to infer the quality indicator for each value of the device state information, by outputting, for each of the values of the device state information, a result of combining output data output from each of the multiple network sections to which machine learning has been applied; and

e) whether the quality indicator, inferred for each of the values of the device state information, satisfies the predetermined conditions, is determined, and replacement time of parts of the semiconductor manufacturing device or maintenance timing of the semiconductor manufacturing device is predicted by using a value of the device state information when the quality indicator satisfies the predetermined conditions.

Thus, according to the first embodiment, it is possible to provide a predicting device that utilizes time series data sets measured along with processing of an object in a semiconductor manufacturing process and device state information acquired during the processing of the object.

### Second Embodiment

In the predicting device 160 according to the first example embodiment, with respect to the configuration in which acquired time series data sets and device state information are processed using multiple network sections, four types of configurations are illustrated. The second embodiment further describes, among these four configurations, a configuration in which time series data sets and device state information are processed using multiple network sections each including a normalizing unit that performs normalization using a different method from other normalizing units. In the following description, a case in which

a time series data acquiring device is an optical emission spectrometer, and

time series data sets are optical emission spectroscopy data (hereinafter referred to as “OES data”), which are data sets including the number, corresponding to the number of types of wavelengths, of sets of time series data of emission intensity will be described.

Hereinafter, the second embodiment will be described focusing on the differences from the above-described first embodiment.

### <Overall Configuration of a System Including a Device Performing a Semiconductor Manufacturing Process and a Predicting Device>

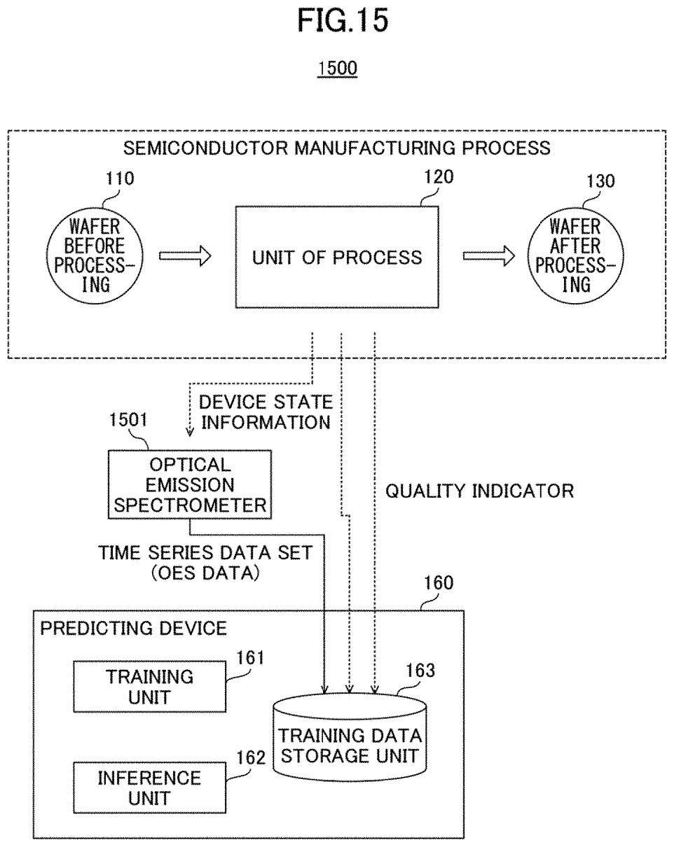

First, the overall configuration of a system including a device performing a semiconductor manufacturing process and a predicting device will be described, in which the time series data acquiring device in the system is an optical emission spectrometer. FIG. 15 is a second diagram illustrating an example of the overall configuration of the system including a device performing a semiconductor manufacturing process and the predicting device. As illustrated in FIG. 15, the system 1500 includes a device for performing a semiconductor manufacturing process, an optical emission spectrometer 1501, and the predicting device 160.

In the system 1500 illustrated in FIG. 15, by using optical emission spectroscopy, the optical emission spectrometer 1501 measures OES data as time series data sets, along with processing of a wafer before processing 110 at the unit of process 120. Part of the OES data measured by the optical emission spectrometer 1501 is stored in the training data storage unit 163 of the predicting device 160 as training data (input data) that is used when performing machine learning.

### <Example of Training Data>

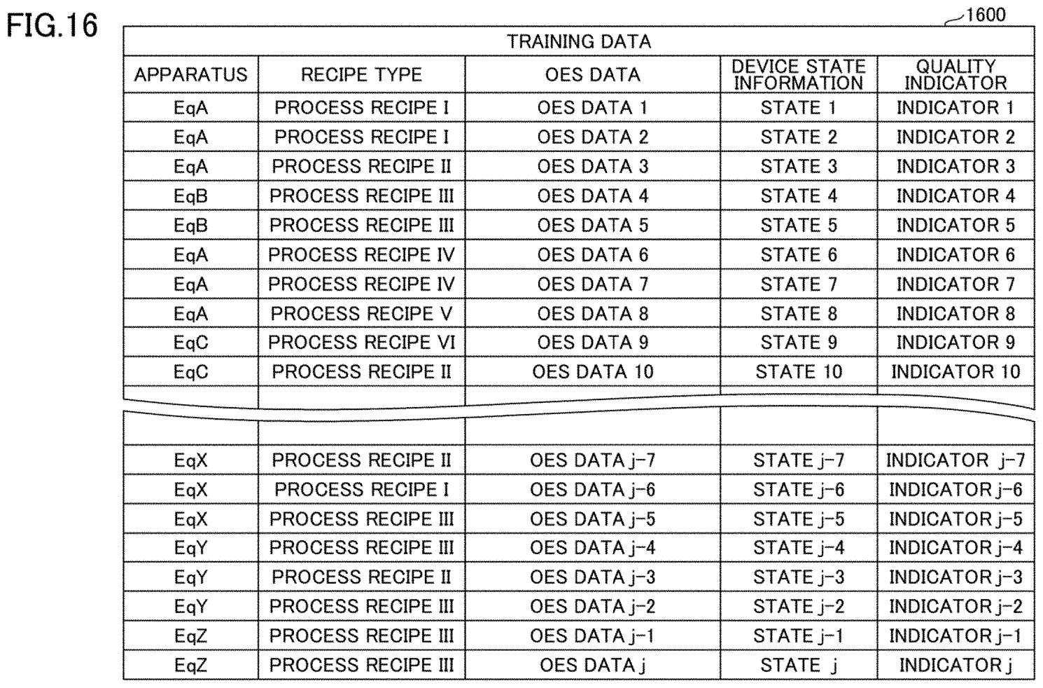

Next, the training data, which is read out from the training data storage unit 163 when the training unit 161 performs machine learning, will be described. FIG. 16 is a second diagram illustrating an example of the training data. As illustrated in FIG. 16, the training data 1600 includes items of information, which are similar to those in the training data 500 illustrated in FIG. 5. The difference from FIG. 5 is that the training data 1600 includes “OES DATA” as an item of information, instead of “TIME SERIES DATA SET” of FIG. 5, and OES data measured by the optical emission spectrometer 1501 is stored in the “OES DATA” field.

### <Specific Example of OES Data>

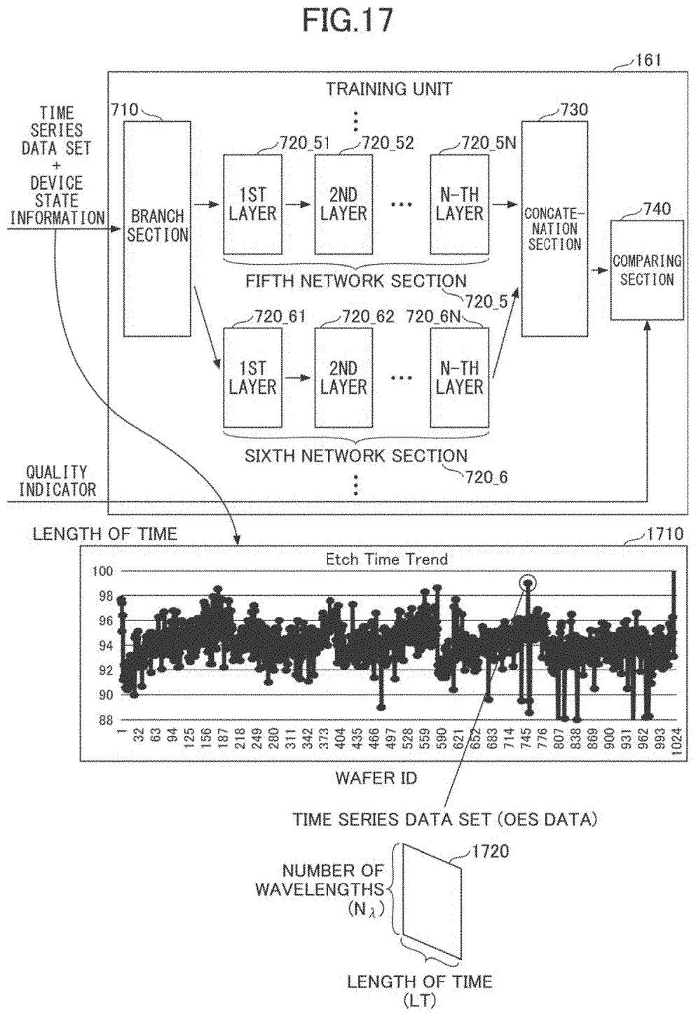

Next, a specific example of the OES data measured in the optical emission spectrometer 1501 will be described. FIG. 17 is a diagram illustrating an example of OES data.

In FIG. 17, the graph 1710 is a graph illustrating characteristics of OES data, which is of time series data sets measured by the optical emission spectrometer 1501. The horizontal axis indicates a wafer identification number for identifying each wafer processed at the unit of process 120. The vertical axis indicates a length of time of the OES data measured in the optical emission spectrometer 1501 along with the processing of each wafer.

As illustrated in the graph 1710, the OES data measured in the optical emission spectrometer 1501 differs in length of time in each wafer to be processed.

In the example of FIG. 17, for example, OES data 1720 represents OES data measured along with the processing of a wafer before processing with wafer identification number=“745”. The vertical size (height) of the OES data 1720 depends on the range of wavelength (number of wavelength components) measured in the optical emission spectrometer 1501. In the second embodiment, the optical emission spectrometer 1501 measures emission intensity within a predetermined wavelength range. Therefore, the vertical size of the OES data 1720 is, for example, the number of types of wavelength (N_{λ}) included within the predetermined wavelength range. That is, N_{λ} is a natural number representing the number of wavelength components measured by the optical emission spectrometer 1501. Note that, in the present embodiment, the number of types of wavelength may also be referred to as the “number of wavelengths”.

Meanwhile, the lateral size (width) of the OES data 1720 depends on the length of time measured by the optical emission spectrometer 1501. In the example of FIG. 17, the lateral size of the OES data 1720 is “LT”.

Thus, the OES data 1720 can be said to be a set of time series data that groups together a predetermined number of wavelengths, where there is one-dimensional time series data of a predetermined length of time for each of the wavelengths.

When the OES data 1720 is input to the fifth network section 720_5 and the sixth network section 720_6, the branch section 710 resizes the data on a per minibatch basis, such that the data size is the same as that of the OES data of other wafer identification numbers.

### <Example of Processing in Normalizing Unit>

Next, a specific example of processing performed by the normalizing units in the fifth network section 720_5 and the sixth network section 720_6, into each of which the OES data 1720 is input from the branch section 710, will be described.

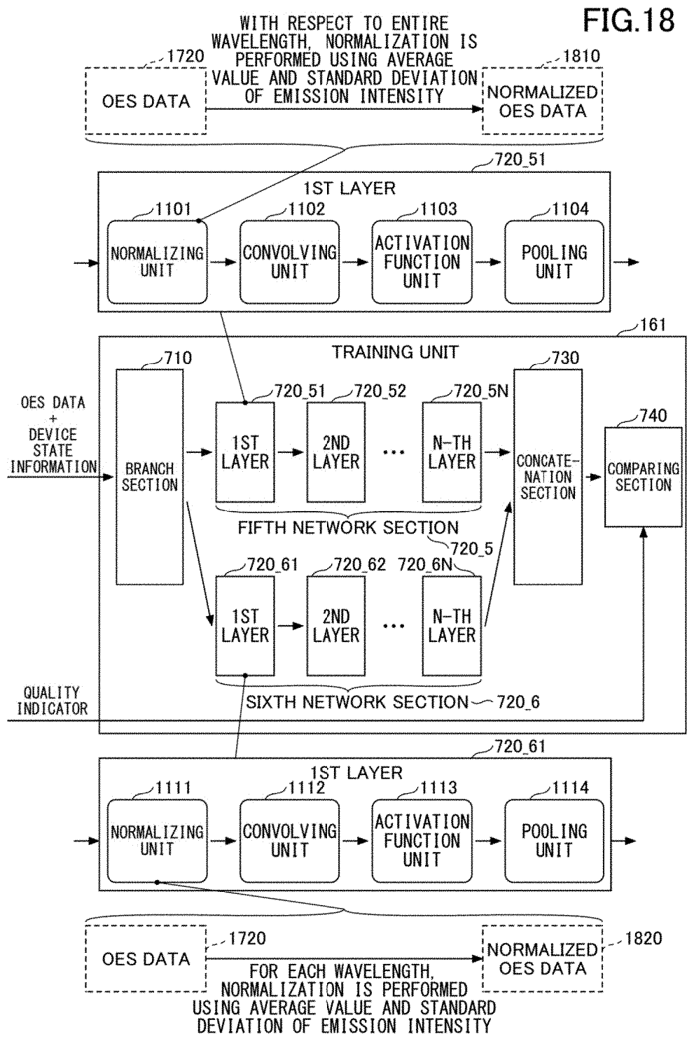

FIG. 18 is a diagram illustrating a specific example of the processing performed by the normalizing units included in the respective network sections into which OES data is input. As illustrated in FIG. 18, among layers included in the fifth network section 720_5, the first layer 720_51 includes the normalizing unit 1101. The normalizing unit 1101 generates normalized data (normalized OES data 1810) by normalizing the OES data 1720 using a first method (normalization based on an average value and a standard deviation of the emission intensity is applied with respect to the entire wavelength). The normalized OES data 1810 is combined with the device state information input from the branch section 710, and is input to the convolving unit 1102.

As illustrated in FIG. 18, among layers included in the sixth network section 720_6, the first layer 720_61 includes the normalizing unit 1111. The normalizing unit 1111 generates normalized data (normalized OES data 1820) by normalizing the OES data 1720 with a second method (normalization based on an average value and a standard deviation of the emission intensity is applied to each wavelength). The normalized OES data 1820 is combined with the device state information input from the branch section 710, and is input to the convolving unit 1112.

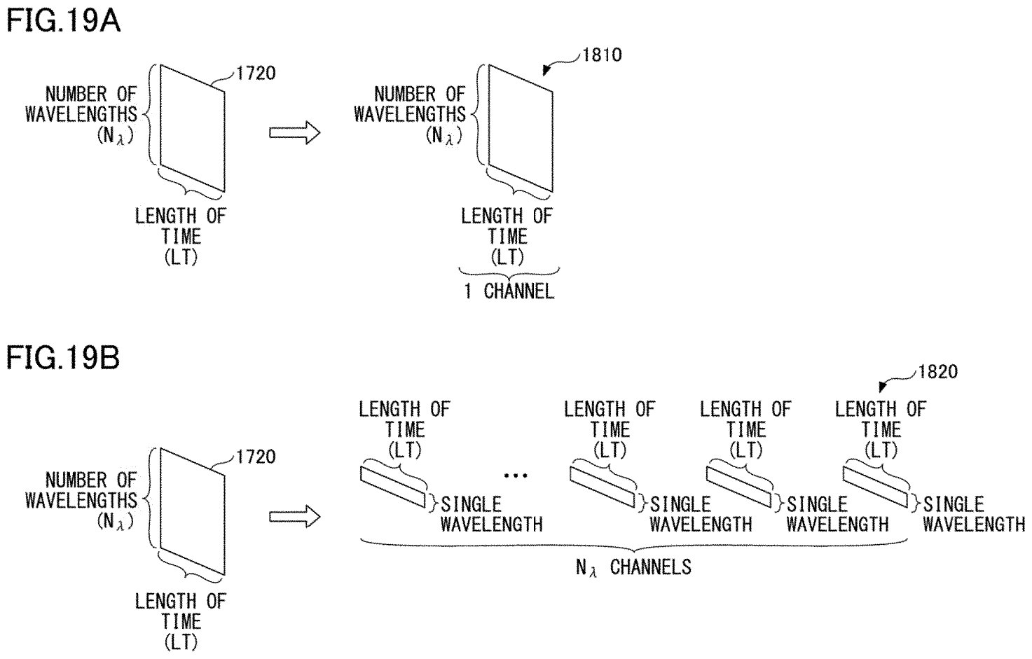

FIGS. 19A and 19B are diagrams illustrating specific examples of processing of each of the normalizing units. FIG. 19A illustrates the processing of the normalizing unit 1101. As illustrated in FIG. 19A, in the normalizing unit 1101, normalization is performed with respect to the entire wavelength using the mean and standard deviation of the emission intensity. Meanwhile, FIG. 19B illustrates the processing of the normalizing unit 1111. In the normalizing unit 1111, normalization using the average and the standard deviation of the emission intensity is applied to each wavelength.

Thus, even though the same OES data 1720 is used, information that will be found out from the same OES data 1720 differs depending on what is used as a reference (i.e., depending on analysis methods). The predicting device 160 according to the second embodiment causes different network sections, each of which is configured to perform a different normalization, to process the same OES data 1720. Thus, by combining multiple normalization processes, it is possible to analyze the OES data 1720 in the unit of process 120 in a multifaceted manner. As a result, a model (inference unit 162) that realizes the high inference accuracy can be generated, as compared to a case in which a single type of normalization process is applied to the OES data 1720 using a single network section.

The above-described example describes a case in which normalization is performed using an average value of emission intensity and a standard deviation of emission intensity. However, a statistical value used for normalization is not limited thereto. For example, the maximum value and a standard deviation of emission intensity may be used for normalization, or other statistics may be used. In addition, the predicting device 160 may be configured such that a user can select types of a statistical value to be used for normalization.

### <Example of Process Performed in Pooling Unit>

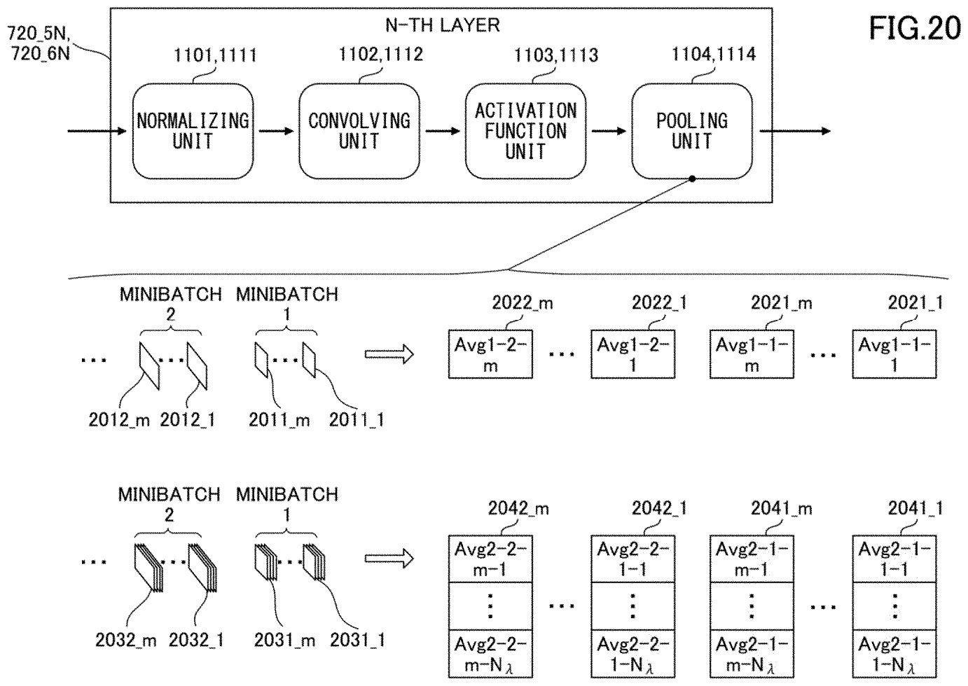

Next, a specific example of the processing performed by the pooling units included in the final layer of the fifth network section 720_5 and in the final layer of the sixth network section 720_6 will be described. FIG. 20 is a diagram illustrating the specific example of the processing performed by the pooling units.

Because data size differs between minibatches, the pooling units 1104 and 1114 included in the respective final layers of the fifth network section 720_5 and the sixth network section 720_6 perform pooling processes such that fixed-length data is output between minibatches (i.e., size of output data according to each minibatch becomes the same).

FIG. 20 is a diagram illustrating a specific example of the processing performed in the pooling units. As illustrated in FIG. 20, the pooling units 1104 and 1114 apply global average pooling (GAP) processing to feature data that is output from the activation function units 1103 and 1113.

In FIG. 20, feature data 2011_1 to 2011_m represent feature data generated based on the OES data belonging to the minibatch 1, and are input to the pooling unit 1104 of the N-th layer 720_5N of the fifth network section 720_5. Each of the feature data 2011_1 to 2011_m represents feature data corresponding to one channel.

Feature data 2012_1 to 2012_m represent feature data generated based on the OES data belonging to the minibatch 2, and are input to the pooling unit 1104 of the N-th layer 720_5N of the fifth network section 720_5. Each of the feature data 2012_1 to 2012_m represents feature data corresponding to one channel.

Also, feature data 2031_1 to 2031_m and feature data 2032_1 to 2032_m are similar to the feature data 2011_1 to 2011_m or the feature data 2012_1 to 2012_m. However, each of the feature data 2031_1 to 2031_m and 2032_1 to 2032_m is feature data corresponding to N_{λ} channels.

Here, the pooling units 1104 and 1114 calculate an average value of feature values included in the input feature data on a per channel basis, to output the fixed-length output data. Thus, the data output from the pooling units 1104 and 1114 can have the same data size between minibatches.

### <Functional Configuration of Inference Unit>

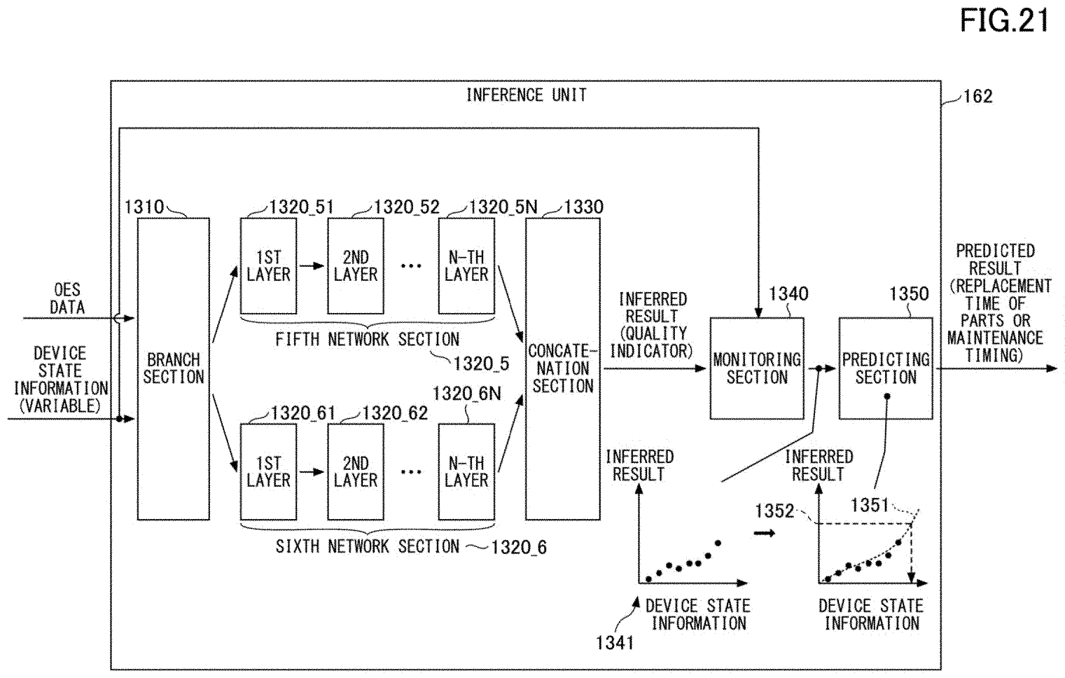

Next, the functional configuration of the inference unit 162 will be described. FIG. 21 is a second diagram illustrating an example of the functional configuration of the inference unit 162. As illustrated in FIG. 21, the inference unit 162 includes a branch section 1310, a fifth network section 1320_5, a sixth network section 1320_6, and a concatenation section 1330.

The branch section 1310 acquires OES data newly measured by the optical emission spectrometer 1501 after the OES data used by the training unit 161 for machine learning was measured, and acquires device state information. The branch section 1310 is also configured to cause both the fifth network section 1320_5 and the sixth network section 1320_6 to process the OES data and the device state information. The device state information can be varied, and the branch section 1310 repeatedly inputs the same time series data sets while changing a value of the device state information.

The fifth network section 1320_5 and the sixth network section 1320_6 are implemented, by performing machine learning in the training unit 161 to optimize model parameters of each of the layers in the fifth network section 720_5 and the sixth network section 720_6.

The concatenation section 1330 is implemented by the concatenation section 730 whose model parameters have been optimized by performing machine learning in the training unit 161. The concatenation section 1330 combines output data that is output from an N-th layer 1320_5N of the fifth network section 1320_5 and from an N-th layer 1320_6N of the sixth network section 1320_6, to output an inference result (quality indicator) for each value of the device state information.

As the monitoring section 1340 and the predicting section 1350 are the same as the monitoring section 1340 and the predicting section 1350 illustrated in FIG. 13, the description thereof will be omitted here.

As described above, the inference unit 162 is generated by machine learning being performed in the training unit 161, which analyzes the OES data with respect to the predetermined unit of process 120 in a multifaceted manner. Thus, the inference unit 162 can also be applied to different process recipes, different chambers, and different devices. Alternatively, the inference unit 162 can be applied to a chamber before maintenance and to the same chamber after its maintenance. That is, the inference unit 162 according to the present embodiment eliminates the need, for example, to maintain or retrain a model after maintenance of the chamber is performed, which was required in conventional systems.

### <Flow of Predicting Process

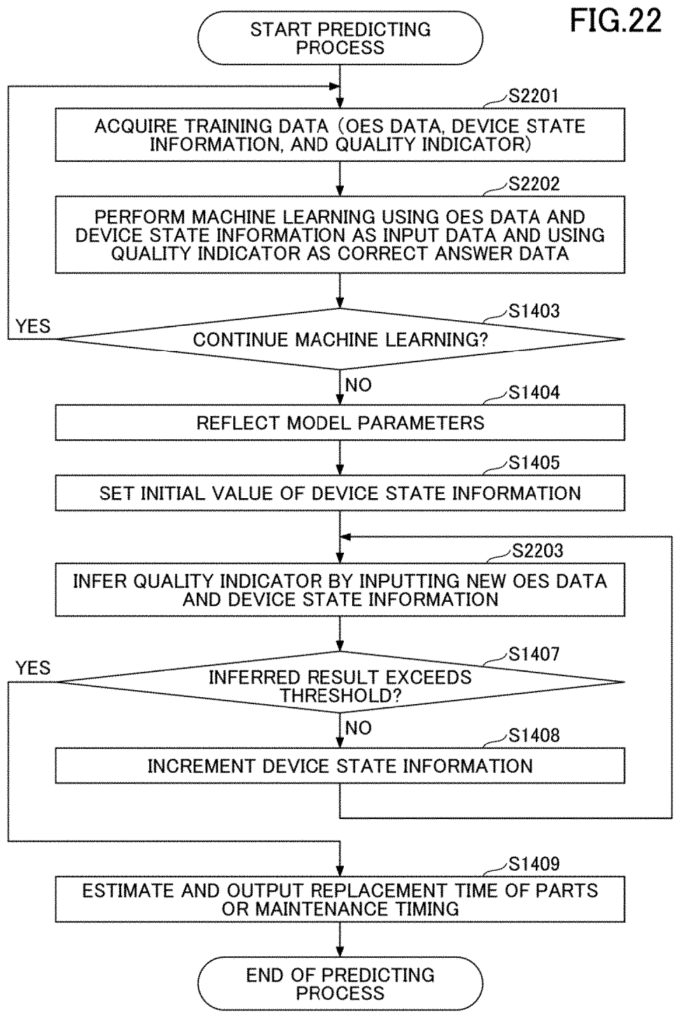

Next, an overall flow of the predicting process performed by the predicting device 160 will be described. FIG. 22 is a second flowchart illustrating the flow of the predicting process. Differences from the first flowchart described with reference to FIG. 14 are steps S2201, S2202, and S2203.

In step S2201, the training unit 161 acquires OES data, device state information, and a quality indicator, as training data.

In step S2202, the training unit 161 performs machine learning by using the acquired training data. Specifically, the OES data and the device state information in the acquired training data are used as input data, and the quality indicator in the acquired training data is used as correct answer data.

In step S2203, the inference unit 162 infers the quality indicator, by inputting OES data sets measured along with processing of a new wafer before processing, and by inputting the value of the device state information.

### SUMMARY

As is apparent from the above description, the predicting device according to the second embodiment performs the following steps:

acquiring, at a predetermined unit of process in a manufacturing process, OES data measured by an optical emission spectrometer along with processing of an object and device state information acquired during the processing of the object;

inputting the acquired OES data and device state information to two network sections each of which performs normalization using a different method from each other;

combining output data output from each of the two network sections;

performing machine learning with respect to the two network sections such that a result of the combining of the output data output from each of the two network sections approaches a quality indicator obtained during the processing of the object at the predetermined unit of process in the manufacturing process;

while changing a value of the device state information, processing OES data measured along with processing of a new object by the optical emission spectrometer, by using the two network sections to which machine learning has been applied;

inferring the quality indicator for each value of the device state information, by outputting a result of combining output data output from each of the two network sections to which machine learning has been applied;

determining whether the quality indicator, inferred for each of the values of the device state information, satisfies the predetermined conditions; and

predicting (estimating) replacement time of parts of the semiconductor manufacturing device or maintenance timing of the semiconductor manufacturing device, by using a value of the device state information when the quality indicator satisfies the predetermined conditions.

Thus, according to the second embodiment, it is possible to provide a predicting device that utilizes OES data, which is time series data sets measured along with processing of an object in a semiconductor manufacturing process, and the device state information acquired during the processing of the object.

### OTHER EMBODIMENTS

In the second embodiment, as an example of a time series data acquiring device, an optical emission spectrometer is described. However, types of the time series data acquiring device applicable to the first embodiment are not limited to the optical emission spectrometer.

For example, examples of the time series data acquiring device described in the first embodiment may include a process data acquiring device that acquires various process data, such as temperature data, pressure data, or gas flow rate data, as one-dimensional time series data. Alternatively, the time series data acquiring device described in the first embodiment may include a radio-frequency (RF) power supply device for plasma configured to acquire various RF data, such as voltage data of the RF power supply, as one-dimensional time series data.

The above-described first and second embodiments are described such that a machine learning algorithm for each of the network sections in the training unit 161 is configured based on a convolutional neural network. However, the machine learning algorithm for each of the network sections in the training unit 161 is not limited to the convolutional neural network, and may be based on other machine learning algorithms.

The first and second embodiments described above have been described such that the predicting device 160 functions as the training unit 161 and the inference unit 162. However, an apparatus serving as the training unit 161 needs not be integrated with an apparatus serving as the inference unit 162, and an apparatus serving as the training unit 161 and an apparatus serving as the inference unit 162 may be separate apparatuses. That is, the predicting device 160 may function as the training unit 161 not including the inference unit 162, or the predicting device 160 may function as the inference unit 162 not including the training unit 161.

The above-described functions of the predicting device 160, such as functions of the training unit 161 and the inference unit 162, may be implemented in a controller of the semiconductor manufacturing device 200, and the controller (inference unit 162) of the semiconductor manufacturing device 200 may predict replacement time of each part in the semiconductor manufacturing device 200. Based on the predicted replacement time, the controller (inference unit 162) of the semiconductor manufacturing device 200 may display a warning message on a display device of the controller, or may operate the semiconductor manufacturing device 200. For example, if the current time reaches the predicted replacement time of a part of the semiconductor manufacturing device 200, the controller (inference unit 162) may stop operations of the semiconductor manufacturing device in order to replace the part.

It should be noted that the present invention is not limited to the above-described configurations, such as configurations described in the embodiments described above, or configurations combined with other elements. Configurations may be changed to an extent not departing from the spirit of the invention, and can be appropriately determined in accordance with their application forms.

What is claimed is:

1. A predicting device comprising:
a processor; and
a non-transitory computer readable medium that has stored therein a computer program that, when executed by the processor, configures the processor to
acquire one or more time series data sets measured along with processing of an object at a predetermined unit of process in a manufacturing process performed by a manufacturing device, and to acquire device state information acquired when the object is processed; and
apply the one or more time series data sets in a neural network to develop a trained model, the neural network including
a plurality of network sections each configured to process the acquired time series data sets and the device state information, and
a concatenation section configured to combine output data output from each of the plurality of network sections as a result of processing the acquired time series data sets, and to output, as a combined result, a result of combining the output data output from each of the plurality of network sections, and
compare the combined result with a quality indicator to train the trained model such that the combined result output from the concatenation section progressively approaches the quality indicator.

2. The predicting device according to claim 1, wherein the processor is further configured to apply the trained model to
repeatedly process one or more time series data sets acquired with respect to a new object at the plurality of the network sections, by repeatedly inputting the time series data sets acquired with respect to the new object into the plurality of the network sections, while changing a value of the device state information;
generate, for each value of the device state information, a combined result by combining, at the concatenation section, output data output from each of the plurality of network sections;
infer a plurality of quality indicators when the new object is processed, by outputting, for each value of the device state information, the combined result generated by the concatenation section as a quality indicator when the new object is processed;
identify a value of the device state information corresponding to the quality indicator that satisfies a predetermined condition from among the plurality of inferred quality indicators; and
predict replacement time of a part in the manufacturing device or maintenance timing of the manufacturing device based on the identified value of the device state information.

3. The predicting device according to claim 1, wherein
the neural network is a convolutional neural network (CNN), and
the processor is further configured to, and
apply the trained model to adapt a unit of process performed during manufacture of a processed object.

4. The predicting device according to claim 1, wherein the processor is further configured to
generate a first time series data set by processing the acquired one or more time series data sets in accordance with a first criterion;
generate a second time series data set by processing the acquired one or more time series data sets in accordance with a second criterion;
cause a first network section of the plurality of network sections to process the first time series data set; and
cause a second network section of the plurality of network sections to process the second time series data set, the second network section being different from the first network section.

5. The predicting device according to claim 4, the processor is further configured to
generate a third time series data set by processing one or more time series data sets acquired with respect to a new object in accordance with the first criterion;
generate a fourth time series data set by processing the time series data sets acquired with respect to the new object in accordance with the second criterion;
during application of the trained model, repeatedly process the third time series data set and the fourth time series data set at the first network section and the second network section of the plurality of the network sections, by repeatedly inputting the third time series data set and the fourth time series data to the first network section and the second network section respectively while changing a value of the device state information;
generate, for each value of the device state information, a combined result by combining, at the concatenation section to which the machine learning has been applied, output data output from each of the plurality of network sections;
infer a plurality of quality indicators by outputting, for each value of the device state information, the combined result generated by the concatenation section as a quality indicator that indicates a quality of the manufacturing process when the new object is processed;
identify the value of the device state information corresponding to the quality indicator that satisfies a predetermined condition from among the plurality of inferred quality indicators; and
predict replacement time of a part in the manufacturing device or maintenance timing of the manufacturing device based on the identified value of the device state information.

6. The predicting device according to claim 1, wherein the processor is further configured to
classify the acquired time series data sets into a plurality of groups, in accordance with a data type or a time range; and
cause each of the plurality of network sections to process a corresponding group from among the plurality of groups and the device state information.

7. The predicting device according to claim 6, processor is further configured to apply the trained model to
classify one or more time series data sets acquired with respect to a new object into a plurality of groups, in accordance with the data type or the time range;
repeatedly process the plurality of groups at the plurality of the network sections, by repeatedly inputting each of the plurality of groups to a corresponding network section of the plurality of network sections, while changing a value of the device state information;
generate, for each value of the device state information, a combined result by combining, at the concatenation section, output data output from each of the plurality of network sections;
infer a plurality of quality indicators by outputting, for each value of the device state information, the combined result generated by the concatenation section as a quality indicator that indicates a quality of the manufacturing process when the new object is processed;
identify the value of the device state information corresponding to the quality indicator that satisfies a predetermined condition from among the plurality of inferred quality indicators; and
predict replacement time of a part in the manufacturing device or maintenance timing of the manufacturing device based on the identified value of the device state information.

8. The predicting device according to claim 1, wherein
the plurality of network sections include respective normalizing units each configured to normalize the acquired time series data sets using a different method from each other; and
each of the plurality of network sections is configured to process the time series data sets after being normalized from among the normalizing units.

9. The predicting device according to claim 8, processor is further configured to apply the trained model to
repeatedly process one or more time series data sets acquired with respect to a new object at the plurality of the network sections, by repeatedly inputting the time series data sets acquired with respect to the new object into the plurality of network sections, while changing a value of the device state information;
generate, for each value of the device state information, a combined result by combining, at the concatenation section, output data output from each of the plurality of network sections;
infer a plurality of quality indicators by outputting, for each value of the device state information, the combined result generated by the concatenation section as a quality indicator that indicates a quality of the manufacturing process when the new object is processed;
identify the value of the device state information corresponding to the quality indicator that satisfies a predetermined condition from among the plurality of quality indicators; and
predict replacement time of a part in the manufacturing device or maintenance timing of the manufacturing device based on the identified value of the device state information.

10. The predicting device according to claim 1, wherein
the acquired time series data sets include a first time series data set measured along with processing of the object in a first processing space and a second time series data set measured along with processing of the object in a second processing space, the processing in the first processing space and the processing in the second processing space being included in the predetermined unit of process; and
the processor is further configured, in processing the acquired time series data sets at the plurality of network sections, to cause a first network section of the plurality of network sections to process the first time series data set and the device state information acquired when the object is processed, and to cause a second network section of the plurality of network sections to process the second time series data set and the device state information acquired when the object is processed, the second network section being different from the first network section.

11. The predicting device according to claim 10, processor is further configured to apply the trained model to
repeatedly process, at the plurality of the network sections, a third time series data set measured along with processing of a new object in the first processing space and a fourth time series data set measured along with processing of the new object in the second processing space, by repeatedly inputting the third time series data set and the fourth time series data set into the first network section and the second network section while changing a value of the device state information, the processing in the first processing space and the processing in the second processing space being included in the predetermined unit of process;
generate, for each value of the device state information, a combined result by combining, at the concatenation section to which the machine learning has been applied, output data output from each of the plurality of network sections;
infer a plurality of quality indicators by outputting, for each value of the device state information, the combined result generated by the concatenation section as a quality indicator that indicates a quality of the manufacturing process when the new object is processed;
identify the value of the device state information corresponding to the quality indicator that satisfies a predetermined condition from among the plurality of inferred quality indicators; and
predict replacement time of a part in the manufacturing device or maintenance timing of the manufacturing device based on the identified value of the device state information.

12. The predicting device according to claim 1, wherein the manufacturing device is a substrate processing apparatus, and the time series data sets are data measured along with processing in the substrate processing apparatus.

13. The predicting device according to claim 8, wherein the time series data sets are data measured by an optical emission spectrometer, along with processing in a substrate processing apparatus, the data indicating emission intensity of each wavelength.

14. The predicting device according to claim 13, wherein
a first network section of the plurality of network sections is configured to perform normalization with respect to an entire wavelength, using a statistical value of the emission intensity.

15. The predicting device according to claim 13, wherein
a second network section of the plurality of network sections is configured to perform normalization for each wavelength, using a statistical value of the emission intensity.

16. The predicting device according to claim 8, wherein
each of the plurality of network sections includes a plurality of layers;
a last layer of the plurality of layers is a pooling layer that performs global average pooling (GAP).

17. The predicting device according to claim 3, wherein the processor is configured to apply the trained model to adapt the unit of process by controlling execution of at least one of
a maintenance operation on a process chamber,
a calibration operation on the process chamber or a component in the process chamber,
an adjustment of power level or waveform of RF energy applied within the process chamber used to generate plasma, or
chuck replacement.

18. A computer-implemented predicting method comprising:
acquiring one or more time series data sets measured along with processing of an object at a predetermined unit of process in a manufacturing process performed by a manufacturing device, and to acquire device state information acquired when the object is processed;
performing machine learning on a processor to implement a plurality of network sections and a concatenation section of a neural network, each of the plurality of network sections being configured to process the acquired time series data sets and the device state information, and the concatenation section being configured to combine output data output from each of the plurality of network sections as a result of processing the acquired time series data sets and to output, as a combined result, a result of combining the output data output from each of the plurality of network sections; wherein
the machine learning is performed to train a trained model such that the combined result output from the concatenation section approaches a quality indicator that indicates a quality of the manufacturing process that is acquired when the object is processed at the predetermined unit of process in the manufacturing process.

19. The method according to claim 18, further comprising
applying the trained model during the manufacturing process to adapt an operation of the predetermined unit of process according to the quality indicator inferred by the trained model based on the predetermined unit of process; wherein
the neural network is a convolutional neural network (CNN).

20. The method according to claim 19, wherein the applying includes at least one of
performing a maintenance operation on a process chamber,
calibrating a component in the process chamber,
adjusting a power level or waveform of RF energy applied within the process chamber used to generate plasma, or
replacing a chuck that holds the object.
